(19) United States
(12) Patent Application Publication
(10) Pub. No.: US 2020/0040157 A1
(43) Pub. Date: Feb. 6, 2020

(54) NANOSUBSTANCE-CONTAINING COMPOSITION

(71) Applicant: OSAKA SODA CO., LTD., Osaka-shi, Osaka (JP)

(72) Inventors: Jitsuo Oda, Osaka-shi, Osaka (JP); Yasushi Konda, Osaka-shi, Osaka (JP); Junya Yamada, Osaka-shi, Osaka (JP); Toyofumi Otaka, Osaka-shi, Osaka (JP); Atsuro Yamazaki, Osaka-shi, Osaka (JP)

(21) Appl. No.: 16/604,122

(22) PCT Filed: Apr. 11, 2018
(86) PCT No.: PCT/JP2018/015196

§ 371 Date: Oct. 9, 2019

(30) Foreign Application Priority Data
Apr. 11, 2017 (JP) 2017-078515
Apr. 11, 2017 (JP) 2017-078541
Apr. 11, 2017 (JP) 2017-078545

(51) Int. Cl. C08K 3/04

(52) U.S. Cl. CPC C08K 3/043; C08K 2201/011

(57) ABSTRACT

Provided is a nanosubstance-containing composition which exhibits excellent heat resistance in cases where a thermoplastic resin or a rubber is contained therein, while exhibiting high toughness in cases where a thermosetting resin is contained therein. A nanosubstance-containing composition according to the present invention contains (a) at least one component selected from the group consisting of thermoplastic resins, thermosetting resins and rubbers, (b) a compound having a reactive functional group and (c) a nanosubstance.

### TECHNICAL FIELD

The present invention relates to a nanosubstance-containing composition and a molded article.

### BACKGROUND ART

A thermoplastic resin has a property of being softened by heating to exhibit plasticity and solidifying by cooling, so that it can be easily molded by heating. Examples of the thermoplastic resin include vinyl polymers such as polyethylene, polypropylene, polystyrene, and polyvinyl chloride, and condensed polymers such as polyesters and polyamides.

Thermoplastic resin is used in various fields such as electric devices, machine parts, and automobile parts because of their characteristics. However, since thermoplastic resin is inferior in heat resistance and chemical resistance as compared with thermosetting resin, solution of this problem is demanded.

Patent Document 1 discloses a resin composition that can provide a resin composition being superior in heat resistance, mechanical strength and transparency due to incorporation of fine cellulose fiber composite into thermoplastic resin or curable resin and also superior in dimension stability depending on the resin, but disclosure of further improved technologies is sought.

On the other hand, thermosetting resins have characteristics such as electric insulation, heat resistance, flame resistance, chemical resistance, mechanical strength, durability, water resistance, and cold resistance, and are used in a wide variety of fields such as power generation products, parts of airplanes, sports items, and household items. While having such characteristics, they are brittle and have problems in impact resistance and fracture strength.

While thermosetting resins have such characteristics, they are brittle and have problems in impact resistance and fracture strength, and solution to the problems is demanded.

Patent Document 2 discloses a thermosetting resin composition having superior heat resistance and also having high toughness by containing a maleimide compound having two or more maleimide groups in one molecule thereof, a phenol compound having two or more in one molecule thereof, and rubber particles having a core-shell structure, but further disclosure of technologies is demanded.

Rubber is used for various materials such as sealing materials, packing materials, hose materials, OA roll materials, tire materials, etc. because of its characteristics such as oil resistance, heat resistance, low friction, chemical resistance, mechanical strength, durability, water resistance, and cold resistance, and is utilized in a wide variety of fields such as semiconductors, automobiles, aircrafts, rockets, ships, electronic devices, chemical plants, and household items.

Although rubber varies in its heat resistance depending on its type, any rubber suffers from deterioration in characteristics such as significant deterioration in mechanical properties, softening, deformation, and adhesion to the surroundings if its temperature exceeds its allowable temperature. Therefore, rubber of any type is required to be improved in heat resistance.

It is generally known to use an anti-aging agent when improving the heat resistance of rubber, and it has been studied in the past in Patent Documents 3 to 6.

### PRIOR ART DOCUMENTS

### Patent Documents

Patent Document 1: Japanese Patent Laid-open Publication No. 2016-155971

Patent Document 2: Japanese Patent Laid-open Publication No. 2013-256586

Patent Document 3: Japanese Patent No. 5682575

Patent Document 4: Japanese Patent Laid-open Publication No. 9-53070

Patent Document 5: Japanese Patent Laid-open Publication No. 10-298551

Patent Document 6: Japanese Patent Laid-open Publication No. 11-21411

### SUMMARY OF THE INVENTION

### Problems to be Solved by the Invention

Then, an object of the present invention is to provide nanosubstance-containing composition which exhibits superior heat resistance in the cases where a thermoplastic resin or a rubber is contained therein and exhibit high toughness in the cases where a thermosetting resin is contained therein, and molded articles containing them.

### Means for Solving the Problem

The present inventors conducted various studies to solve the above problems, and have found that a nanosubstance-containing composition containing at least one component (a) selected from the group consisting of thermoplastic resins, thermosetting resins, and rubbers, a compound having a reactive functional group (b), and a nanosubstance (c) can solve the problems.

That is, the present invention can be described as follows:

Item 1. A nanosubstance-containing composition containing:

at least one component (a) selected from the group consisting of thermoplastic resins, thermosetting resins, and rubbers;

a compound having a reactive functional group (b); and

a nanosubstance (c).

Item 2. The nanosubstance-containing composition according to Item 1, wherein the compound having a reactive functional group (b) is a compound having at least one or more reactive functional groups selected from the group consisting of a vinyl group, an allyl group, an epoxy group, a hydroxyl group, a carboxyl group, a (meth)acryloyl group, an isocyanate group, a mercapto group, and a silanol group.
Item 3. The nanosubstance-containing composition according to Item 1 or 2, wherein the compound having a reactive functional group (b) is a compound having a boiling point of 100° C. or higher at normal pressure.
Item 4. The nanosubstance-containing composition according to any one of Items 1 to 3, wherein the nanosubstance (c) is at least one nanofiller selected from the group consisting of carbon-based nanofillers, organic nanofillers, and inorganic nanofillers.
Item 5. The nanosubstance-containing composition according to any one of Items 1 to 4, wherein the thermosetting resin is an allyl resin.
Item 6. A cured product of the nanosubstance-containing composition according to any one of Items 1 to 5.
Item 7. A molded article produced from the nanosubstance-containing composition according to any one of Items 1 to 5.

### Advantages of the Invention

According to the present invention, there can be provided nanosubstance-containing composition which exhibits superior heat resistance in the cases where a thermoplastic resin or a rubber is contained therein and exhibit high toughness in the cases where a thermosetting resin is contained therein, and molded articles containing them. The nanosubstance-containing compositions of the present invention and molded articles containing the same are usefully used in various fields such as electric devices, machine parts, and automobile parts.

### EMBODIMENTS OF THE INVENTION

The nanosubstance-containing composition according to the present invention is characterized by containing at least one component (a) selected from the group consisting of thermoplastic resins, thermosetting resins, and rubbers, a compound having a reactive functional group (b), and a nanosubstance (c). Hereafter, the nanosubstance-containing composition of the present invention will be described in detail.

### 1. Component (a)

Component (a) is at least one species selected from the group consisting of thermoplastic resins, thermosetting resins, and rubbers.

### (1) Thermoplastic Resin

The thermoplastic resin is not particularly limited, and examples thereof include polycarbonate resins, styrene resins (polystyrene resin, ABS (acrylonitrile-butadiene-styrene) resin, AS (acrylonitrile-styrene) resin, etc.), olefin resins such as polyethylene and polypropylene, polyphenylene sulfide resins, polyvinyl chloride resins (PVC), polymethacrylate resins, polyamide resins, polyester resins such as polyethylene terephthalate (PET) and polybutylene terephthalate (PBT), polysulfone resins (PSF), polyacetal resins, polyether ether ketone resins (PEEK), polyether imide resins (PEI), polyether sulfone resins (PES), polyphenylene sulfide resins (PPS), polyacetal resins (POM), polyamide imide resins (PAI), and polyimide resins (PI), and polycarbonate resins, polyester resin such as polyethylene terephthalate (PET) and polybutylene terephthalate (PBT), styrene resins, and olefin resins such as polyethylene and polypropylene are preferable. As to the thermoplastic resin, one species thereof may be used, or two or more species thereof may be used in combination.

### (2) Thermosetting Resin

The thermosetting resin is not particularly limited, and examples thereof include epoxy resin, phenol resin, unsaturated imide resin, cyanate resin, isocyanate resin, benzoxazine resin, oxetane resin, amino resin, unsaturated polyester resin, allyl resin such as diallyl phthalate resin and allyl diglycol carbonate resin, dicyclopentadiene resin, silicone resin, triazine resin, and melamine resin, more preferred are allyl resins such as diallyl phthalate resin and allyl diglycol carbonate resin, and epoxy resin, and particularly preferred are diallyl phthalate resins derived from diallyl orthophthalate and diallyl isophthalate, and epoxy resin. One species or a combination of two or more species of these resins may be used. Use of a plurality of resins includes use of one resin as a curing agent.

### (3) Rubber

The rubber is not particularly limited, and examples thereof include acrylonitrile butadiene rubber (NBR), hydrogenated NBR (H-NBR), acrylic rubber (ACM), ethylene acrylate rubber (AEM), fluorine-containing rubber (FKM), chloroprene rubber (CR), chlorosulfonated polyethylene (CSM), chlorinated polyethylene (CPE), ethylene propylene rubbers (EPM, EPDM), and polyether rubber. One species or a combination of two or more species of these rubbers may be used.

Acrylonitrile butadiene rubber (hereinafter abbreviated to NBR) is not particularly limited as long as the rubber is one containing polymerization units based on acrylonitrile and butadiene. The copolymerization composition of acrylonitrile and butadiene is not particularly limited, and generally, one having a bonded acrylonitrile content of 30% or more and 50% or less is used. It is also allowable to use a blend composed of NBR and vinyl chloride resin (hereinafter abbreviated to PVC), a blend composed of NBR and ethylene propylene diene rubber (EPDM), or the like. It is also allowable to use acrylate-modified NBR, partially crosslinked NBR, terminal-modified NBR, and the like. The form thereof is not particularly limited as long as the form is a common form of NBR, and powdery NBR or liquid NBR can be used.

Hydrogenated NBR (hereinafter abbreviated to H-NBR) is not particularly limited as long as it has a structure in which the butadiene units of the NBR are hydrogenated. It is not particularly limited with respect to its composition, but since it is commonly produced from NBR, the composition is equivalent to that of the NBR. One obtained by hydrogenating all of the butadiene units, or one obtained by hydrogenating the units to make some unsaturated bonds thereof to remain can also be used. Its blend with another polymer, its modified product, or the like can also be used like NBR.

Acrylic rubber (hereinafter abbreviated as ACM) is not particularly limited as long as it is a synthetic rubber obtainable by polymerizing an acrylate as a main polymerization unit. A side-chain alkyl or alkoxyalkyl group of the acrylic ester is not particularly limited and is generally decided according to the balance between oil resistance and cold resistance, and the acrylic ester is preferably an alkyl acrylate in which the alkyl has 1 to 4 carbon atoms or an alkoxyalkyl acrylate in which the alkoxy group has 1 to 4 carbon atoms. Examples thereof include methyl acrylate, ethyl acrylate, propyl acrylate, n-butyl acrylate, methoxymethyl acrylate, methoxyethyl acrylate, ethoxyethyl acrylate, and butoxyethyl acrylate. An acrylic rubber in which a functional group that may be of various types is introduced as side chains into crosslinking sites thereof may be commonly used, and examples of a monomer to be used in common crosslinking sites include chlorine group-based monomers such as 2-chloroethyl vinyl ether; active chlorine group-based monomers such as vinyl chloroacetate; and epoxy group-based monomers such as allyl glycidyl ether and glycidyl acrylate. In ACM, the proportion of units of the monomer to be used in the crosslinking sites may be 0.1 to 10% by mass for 100% by mass of the acrylate monomer units.

The ethylene acrylate rubber (hereinafter abbreviated to AEM) is a copolymer made from ethylene and an acrylate, and such a copolymer obtained by further introducing, into crosslinking sites thereof, a functional group that may be of various types, is also commonly used. Examples of a common crosslinking site include one where a carboxyl group is to be introduced to a side chain. The composition ratio of ethylene to the acrylate is not particularly limited, and it is decided according to oil resistance, cold resistance, and workability. In AEM, the proportion of the monomer units to be used in the crosslinking sites may be 0.1 to 10% by mass for 100% by mass of the total of the acrylate monomer units and the ethylene monomer units.

Fluorine-containing rubber (hereinafter abbreviated to FKM) is a synthetic rubber containing, in its main chain or side chain(s), a fluorine atom. As the composition of FKM, commonly known one may be employed. Examples thereof include a vinylidene fluoride-hexafluoropropylene copolymer, a vinylidene fluoride-hexafluoropropylene-tetrafluoroethylene terpolymer, a tetrafluoroethylene-propylene copolymer, a tetrafluoroethylene-propylene-vinylidene fluoride terpolymer, and a tetrafluoroethylene-perfluoro(alkyl vinyl ether) copolymer. It is allowable to use a product obtained by introducing crosslinking sites into any one of these polymers. It is also allowable to use a product obtained by introducing bromine or iodine into such a polymer in order to improve the crosslinking property for peroxide crosslinking. The composition ratio of these polymers is not particularly limited, and conventional products may be used.

Chloroprene rubber (hereinafter abbreviated to CR) is a polymer made from a chloroprene monomer. While the method for synthesizing a chloroprene monomer is classified into an acetylene method and a butadiene method, there can be employed CR obtained by polymerizing a chloroprene monomer produced by either one of these synthesizing methods. When a chloroprene monomer is polymerized, the resultant polymer usually has a structure composed of a trans-1,4-polychloroprene unit, a cis-1,4-polychloroprene unit, a 1,2-polychloroprene unit, and a 3,4-polychloroprene unit and the composition ratio between these units is not particularly limited. It is allowable to use a known modified chloroprene rubber that has been modified with sulfur, a mercapto group, or some other. CR may be a copolymer made from a chloroprene monomer and a monomer copolymerizable with chloroprene, and examples of the copolymerizable monomer include 2,3-dichloro-1,3-butadiene, 1-chloro-1,3-butadiene, butadiene, isoprene, styrene, acrylonitrile, acrylic acid or esters thereof, and methacrylic acid or esters thereof.

Chlorosulfonated polyethylene (hereinafter abbreviated to CSM) is a synthetic rubber obtained by chlorinating and chlorosulfonating polyethylene with chlorine and sulfurous acid gas. The molecular weight, the chlorine content, the content of chlorosulfone groups are not particularly limited, and conventional products may be used.

Chlorinated polyethylene (hereinafter abbreviated to CPE) is a synthetic rubber obtained by chlorinating polyethylene with chlorine gas. The molecular weight and the chlorine content are not particularly limited, and conventional products may be used.

Ethylene propylene rubbers (EPM and EPDM) are a copolymer made from ethylene and propylene (hereinafter abbreviated to EPM) and a copolymer in which a diene component is introduced as a third component thereinto (hereinafter abbreviated to EPDM). The diene component to be used as the third component may be known one, and examples thereof include dicyclopentadiene, 5-ethylidene-2-norbornene, and 1,4-hexadiene. The composition may be known one, and the molecular weight and the form thereof are not particularly limited, and conventional products may be used.

The polyether rubber is not particularly limited as long as it is an uncrosslinked (vulcanized) polymer having a polymerization unit based on an oxirane monomer.

Examples of the oxirane monomer include oxirane monomers having an alkyl group such as ethylene oxide, propylene oxide, and butylene oxide such as 1,2-butylene oxide; oxirane monomers having an alkyloxy group such as methyl glycidyl ether, ethyl glycidyl ether, butyl glycidyl ether, hexyl glycidyl ether, 2-ethylhexyl glycidyl ether, and methoxyethoxyethyl glycidyl ether; oxirane monomers having a cycloalkyl group such as 1,2-epoxycyclopentane, 1,2-epoxycyclohexane, and 1,2-epoxycyclododecane; oxirane monomers having an aromatic group such as styrene oxide and phenyl glycidyl ether; oxirane monomers having an ester group such as propyl 2,3-epoxybutanoate; and oxirane monomers having a hydroxyl group such as 4,5-epoxy-1-butanol and 3,4-epoxy-1-butanol.

The polyether rubber may have a polymerization unit based on an oxirane monomer having a crosslinkable functional group. Examples thereof include epihalohydrin monomers such as epichlorohydrin, epibromohydrin, epiiodohydrin, and epifluorohydrin; halogen-substituted oxirane monomers other than epihalohydrin monomers such as p-chlorostyrene oxide, dibromophenyl glycidyl ether, m-chloromethylstyrene oxide, p-chloromethylstyrene oxide, glycidyl chloroacetate, chloromethyl glycidate, tetrafluorooxirane, and 1,1,2,3,3,3-hexafluoro-1,2-epoxypropane; and ethylenically unsaturated group-containing oxirane monomers such as allyl glycidyl ether, glycidyl acrylate, glycidyl methacrylate, glycidyl crotonate, and 3,4-epoxy-1-butene.

The polyether rubber may be a homopolymer composed only of polymerization units based on a single type of oxirane monomers or alternatively may be a polymer having polymerization units based on two or more types of oxirane monomers.

The polyether rubber may be epichlorohydrin rubber (ECO) having a polymerization unit based on an epichlorohydrin monomer, and preferred as another monomer other than epichlorohydrin is, for example, at least one monomer selected from the group consisting of ethylene oxide, propylene oxide, and allyl glycidyl ether. The rubber is preferably a polymer having a polymerization unit based on epichlorohydrin and a polymerization unit based on ethylene oxide, and is more preferably a polymer having a polymerization unit based on epichlorohydrin, a polymerization unit based on ethylene oxide, and a polymerization unit based on allyl glycidyl ether.

As the ECO, preferred is at least one polymer selected from the group consisting of, for example, an epichlorohydrin homopolymer, an epichlorohydrin-ethylene oxide copolymer, an epichlorohydrin-allyl glycidyl ether copolymer, an epichlorohydrin-ethylene oxide-allyl glycidyl ether copolymer, an epichlorohydrin-ethylene oxide-allyl glycidyl ether copolymer, an epichlorohydrin-propylene oxide copolymer, an epichlorohydrin-propylene oxide-allyl glycidyl ether copolymer, and an epichlorohydrin-ethylene oxide-propylene oxide-allyl glycidyl ether tetrapolymer. More preferred is at least one polymer selected from among an epichlorohydrin-ethylene oxide copolymer and an epichlorohydrin-ethylene oxide-allyl glycidyl ether copolymer. These may be used alone or in the form of a mixture of two or more thereof.

### 2. Compound Having Reactive Functional Group (b)

Examples of the compound having a reactive functional group (b) include compounds having at least one or more vinyl groups, allyl groups, epoxy groups, hydroxyl groups, carboxyl groups, (meth)acryloyl groups, isocyanate groups, mercapto groups, or silanol group; a compound having a vinyl group or an allyl group is preferable, and a compound having an allyl group is more preferable.

It is desirable that the compound having a reactive functional group (b) does not volatilize at a temperature at which the component (a), the compound having a reactive functional group (b), and the nanosubstance (c) are kneaded (mixed), and it is preferred to have a boiling point of 100° C. or higher under normal pressure.

Examples of the compound having a vinyl group include compounds having a vinyl group and an organic group such as an aliphatic hydrocarbon group, an aromatic hydrocarbon group, or an alicyclic hydrocarbon group, and examples thereof include styrene, vinyl chloride, and vinyl acetate.

The compound having an allyl group is preferably any one of allyl esters, allyl ethers, allylamines, allyl cyanurates, allyl isocyanurates, allyl thioethers, and allyloniums, more preferably any one of polyfunctional allyl esters, polyfunctional allyl ethers, polyfunctional allylamines, polyfunctional cyanurates, polyfunctional isocyanurates, and polyfunctional allyl thioethers, which are compounds having two or more allyl groups in the same molecule, and particularly preferably a polyfunctional allyl ester or a polyfunctional allyl ether.

Examples of the allyl ester include a monofunctional allyl ester and a polyfunctional allyl ester.

As the monofunctional allyl ester, a monofunctional allyl ester selected from among an aliphatic monofunctional allyl ester, an alicyclic monofunctional allyl ester, and an aromatic monofunctional allyl ester is used. In the present specification, the term “monofunctional allyl ester” means a compound having one allyl ester group (—COOCH₂—CH═CH₂ group), the term “aliphatic monofunctional allyl ester” means a compound having an aliphatic hydrocarbon group and one allyl ester group, the term “alicyclic monofunctional allyl ester” means a compound having an alicyclic hydrocarbon group and one allyl ester group, and the term “aromatic monofunctional allyl ester” means a compound having an aromatic hydrocarbon group and one or more allyl ester groups.

Examples of the aliphatic hydrocarbon group in the monofunctional allyl ester include alkyl groups, alkenyl groups, and alkynyl groups having 1 to 18 carbon atoms; alkyl groups, alkenyl groups, and alkynyl groups having 1 to 12 carbon atoms are preferable, and alkyl groups, alkenyl groups, and alkynyl groups having 1 to 6 carbon atoms are more preferable.

The number of the carbon atoms of the alicyclic hydrocarbon group in the monofunctional allyl ester is preferably 3 to 18, more preferably 4 to 12, and particularly preferably 4 to 10. In particular, it is preferable that all the carbon atoms constituting the alicyclic hydrocarbon group form a ring structure. That is, the alicyclic hydrocarbon group is preferably a 3- to 18-membered ring, more preferably a 4- to 12-membered ring, and particularly preferably a 4- to 10-membered ring.

The alicyclic hydrocarbon group may be a saturated alicyclic hydrocarbon group or may have an unsaturated bond in part. Especially, a saturated alicyclic hydrocarbon group is preferable. In the present invention, the term “alicyclic” means having a cyclic structure with no aromaticity, and the term “alicyclic hydrocarbon group” means a hydrocarbon group having a cyclic structure with no aromaticity.

The alicyclic hydrocarbon group may have a substituent such as an alkyl group, an alkoxy group, a halogen atom, an allyl group, a vinyl group, or a hydroxy group.

The number of the carbon atoms of the aromatic hydrocarbon group in the monofunctional allyl ester is preferably 6 to 18, more preferably 6 to 12, and particularly preferably 6 to 8.

The aromatic hydrocarbon group may have a substituent such as an alkyl group, an alkoxy group, a halogen atom, an allyl group, a vinyl group, or a hydroxy group.

The aromatic hydrocarbon group may be a polycyclic aromatic hydrocarbon group.

As the polyfunctional allyl ester, a polyfunctional allyl ester selected from among aliphatic polyfunctional allyl esters, alicyclic polyfunctional allyl esters, and aromatic polyfunctional allyl esters is used, and it is preferably a polyfunctional allyl ester represented by the formula (1). The allyl ester selected from among aliphatic polyfunctional allyl esters, alicyclic polyfunctional allyl esters, and aromatic polyfunctional allyl esters may be either one species or a combination of two or more species. In the present description, the term “polyfunctional allyl ester” means a compound having two or more allyl ester groups (—COOCH₂—CH═CH₂ groups), the term “aliphatic polyfunctional allyl ester” means a compound having an aliphatic hydrocarbon group and two or more allyl ester groups, the term “alicyclic polyfunctional allyl ester” means a compound having an alicyclic hydrocarbon group and two or more allyl ester groups, and the term “aromatic polyfunctional allyl ester” means a compound having an aromatic hydrocarbon group and two or more allyl ester groups. In the present description, the term “aliphatic polyfunctional allyl ester” is a concept including diallyl oxalate in which two allyl ester groups are directly bonded together.

[Chemical Formula 1]

zCOCH₂—CH═CH₂H)ₙ (1)

wherein n represents an integer of 2 or more, z is an n-valent aliphatic hydrocarbon group, an n-valent alicyclic hydrocarbon group, an n-valent aromatic hydrocarbon group, or a bond (only when n is 2).

In the formula (1), n is more preferably 2 or 3, and particularly preferably 2.

In the formula (1), the number of the carbon atoms of the n-valent aliphatic hydrocarbon group is preferably 1 to 18, more preferably 2 to 12, even more preferably 2 to 6, particularly preferably 2 to 4, and most preferably 2 to 3.

The n-valent aliphatic hydrocarbon group may have a branched structure, but it is preferably a linear hydrocarbon group having no branched structure.

The n-valent aliphatic hydrocarbon group may have a substituent such as an alkoxy group, a halogen atom, an allyl group, a vinyl group, or a hydroxy group.

Examples of the divalent aliphatic hydrocarbon group include alkylene groups, alkenylene groups, and alkynylene groups having 1 to 18 carbon atoms, and alkenylene groups are preferable. Examples of the alkenylene group include a vinylene group, a 1-propenylene group, a 2-propenylene group, a 1-butenylene group, a 2-butenylene group, a 1-pentenylene group, a 2-pentenylene group, a 1-hexenylene group, a 2-hexenylene group, and a 1-octenylene group. Among these, a vinylene group is preferable.

In the formula (1), the number of the carbon atoms of the n-valent alicyclic hydrocarbon group is preferably 3 to 18, more preferably 4 to 12, and particularly preferably 4 to 10. In particular, it is preferable that all the carbon atoms constituting the alicyclic hydrocarbon group form a ring structure. That is, the n-valent alicyclic hydrocarbon group is preferably a 3- to 18-membered ring, more preferably a 4- to 12-membered ring, and particularly preferably a 4- to 10-membered ring.

The n-valent alicyclic hydrocarbon group may be a saturated n-valent alicyclic hydrocarbon group or may have an unsaturated bond in part. Especially, a saturated n-valent alicyclic hydrocarbon group is preferable. In the present invention, the term “alicyclic” means having a cyclic structure with no aromaticity, and the term “alicyclic hydrocarbon group” means a hydrocarbon group having a cyclic structure with no aromaticity.

The n-valent alicyclic hydrocarbon group may have a substituent such as an alkyl group, an alkoxy group, a halogen atom, an allyl group, a vinyl group, or a hydroxy group.

In the formula (1), the number of the carbon atoms of the n-valent aromatic hydrocarbon group is preferably 6 to 18, more preferably 6 to 12, and particularly preferably 6 to 8.

The n-valent aromatic hydrocarbon group may have a substituent such as an alkyl group, an alkoxy group, a halogen atom, an allyl group, a vinyl group, or a hydroxy group.

The aromatic hydrocarbon group may be a polycyclic aromatic hydrocarbon group.

When z is a bond in the formula (1), the polyfunctional allyl ester represented by the formula (1) is diallyl oxalate.

Examples of the polyfunctional allyl ester represented by the formula (1) in the case where z is an n-valent aliphatic hydrocarbon group in the formula (1) include diallyl oxalate, diallyl malonate, diallyl succinate, diallyl glutarate, diallyl adipate, diallyl pimelate, diallyl suberate, diallyl azelate, diallyl sebacate, diallyl fumarate, diallyl maleate, triallyl citrate, diallyl itaconate, and tetraallyl 1,2,3,4-butanetetracarboxylate.

Examples of the polyfunctional allyl ester represented by the formula (1) in the case where z is an n-valent alicyclic hydrocarbon group in the formula (1) include alicyclic polyfunctional allyl esters such as compounds represented by formulas (2) to (9).

Preferred is any one of the compounds represented by:

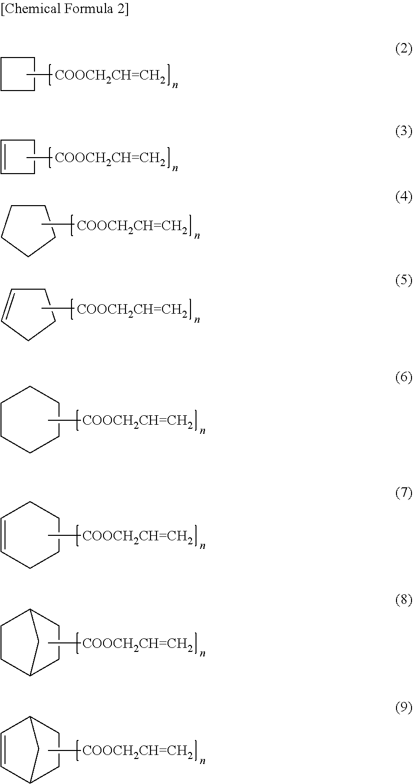

wherein n is an integer of 2 to 4.

In the formulas (2) to (9), a bridge may be formed in the ring structure, and examples of a ring structure in which a bridge is formed include adamantane and norbornane.

The positions of substitution with the COOCH₂—CH═CH₂ groups on the ring in the formulas (2) to (9) may be any combination or a mixture thereof. In particular, when two COOCH₂—CH═CH₂ groups are attached to a 6-membered ring, the two COOCH₂—CH═CH₂ groups may be in any of ortho-orientation, meta-orientation, and para-orientation, but they are preferably in ortho-orientation or meta-orientation, and particularly preferably in meta-orientation.

Examples of the alicyclic polyfunctional allyl ester include diallyl cyclobutanedicarboxylate, diallyl cycloheptanedicarboxylate, diallyl cyclohexanedicarboxylate (diallyl hexahydrophthalate), diallyl norbomanedicarboxylate, diallyl cyclobutenedicarboxylate, diallyl cycloheptenedicarboxylate, diallyl cyclohexenedicarboxylate (diallyl tetrahydrophthalate), diallyl norbomenedicarboxylate, 3-methyl-hexahydro-1,2-diallyl phthalate, 4-methyl-hexahydro-1,2-diallyl phthalate, 3-methyl-1,2,3,6-tetrahydro-1,2-diallyl phthalate, 4-methyl-1,2,3,6-tetrahydro-1,2-diallyl phthalate, 3,6-endomethylene-3-methyl-1,2,3,6-tetrahydro-1,2-diallyl phthalate, 3,6-endomethylene-4-methyl-1,2,3,6-tetrahydro-1,2-diallyl phthalate, diallyl 4-cyclohexene-1,2-dicarboxylate, diallyl 2-cyclohexene-1,2-dicarboxylate, and tetraallyl 1,2,3,4-butanetetracarboxylate. Among these, diallyl 1,2-cyclohexanedicarboxylate, diallyl 1,3-cyclohexanedicarboxylate, diallyl 1,4-cyclohexanedicarboxylate, and diallyl norbomanedicarboxylate are preferred.

In the polyfunctional allyl ester represented by the formula (1) in the case where z is an n-valent aromatic hydrocarbon group in the formula (1), the positions substitution with the allyl ester (COOCH₂CH═CH₂) groups on the ring may be any combination or a mixture thereof. In particular, when two COOCH₂CH═CH₂ groups are attached to a 6-membered ring, the two COOCH₂CH═CH₂ groups may be in any of ortho-orientation, meta-orientation, and para-orientation, but they are preferably in ortho-orientation or meta-orientation, and particularly preferably in meta-orientation.

Examples of the polyfunctional allyl ester represented by the formula (1) in the case where z is an n-valent alicyclic hydrocarbon group in the formula (1) include aromatic polyfunctional allyl esters such as compounds represented by the formula (10).

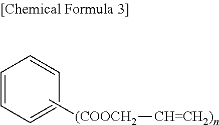

wherein n is an integer of 2 to 6.

Examples of the aromatic polyfunctional allyl ester include diallyl phthalates (diallyl orthophthalate, diallyl isophthalate, and diallyl terephthalate), triallyl trimesate, triallyl trimellitate, tetraallyl pyromellitate, hexaallyl benzenehexacarboxylate, hexaallyl mellitate, and 1,3,5,7-tetraallylnaphthalene; among these, triallyl trimesate and diallyl phthalate are preferred.

Among the polyfunctional allyl esters, preferred are polyfunctional allyl esters having a cyclic structure and having two COOCH₂—CH═CH₂ groups such as alicyclic polyfunctional allyl esters and aromatic polyfunctional allyl esters.

Examples of the allyl ether include a monofunctional allyl ether and a polyfunctional allyl ether.

The term “monofunctional allyl ether” means a compound having one allyl ether group (—O—CH₂—CH═CH₂ group), and examples thereof include ethylene glycol monoallyl ether, diethylene glycol monoallyl ether, polyethylene glycol monoallyl ether, propylene glycol monoallyl ether, and butylene glycol monoallyl ether.

The term “polyfunctional allyl ether” means a compound having two or more allyl ether groups (—O—CH₂—CH═CH₂ groups), examples of which include ethylene glycol diallyl ether, diethylene glycol diallyl ether, polyethylene glycol diallyl ether, propylene glycol diallyl ether, butylene glycol diallyl ether, hexanediol diallyl ether, a bisphenol A alkylene oxide diallyl ether, a bisphenol F alkylene oxide diallyl ether, trimethylolpropane triallyl ether, ditrimethylolpropane tetraallyl ether, glycerin triallyl ether, pentaerythritol tetraallyl ether, dipentaerythritol pentaallyl ether, dipentaerythritol hexaallyl ether, polyethylene glycol diallyl ether, pentaerythritol diallyl ether, pentaerythritol triallyl ether, pentaerythritol tetraallyl ether, 1,4-diallyloxymethylbenzene, ethylene oxide-added trimethylolpropane triallyl ether, ethylene oxide-added ditrimethylolpropane tetraallyl ether, ethylene oxide-added pentaerythritol tetraallyl ether and ethylene oxide-added dipentaerythritol hexaallyl ether; among these, polyethylene glycol diallyl ether is preferred.

Examples of the allylamine include a monofunctional allyl amine and a polyfunctional allyl amine.

The term “monofunctional allylamine” means an amine having one allyl group (—CH₂—CH═CH₂ group), and examples thereof include allyldimethylamine and allyldiethylamine.

The term “polyfunctional allylamine” means an amine having two or more allyl groups (—CH₂—CH═CH₂ groups), which is preferably an amine including an alicyclic or dialicyclic compound with —NH—CO—NH— as the skeleton thereof and having two or more allyl groups (—CH₂—CH═CH₂ groups), and more preferably an amine having a glycoluril skeleton and two or more allyl groups (—CH₂—CH═CH₂ groups). Examples of the polyfunctional allylamine include diallylamine, diallylmethylamine, diallylethylamine, triallylamine, and 1,3,4,6-tetralylglycoluril.

The allyl cyanurate is a compound having an allyl group and a cyanuric acid skeleton, and examples thereof include allyl cyanurate, diallyl cyanurate, and triallyl cyanurate.

The allyl isocyanurate is a compound having an allyl group and an isocyanuric acid skeleton, and examples thereof include allyl isocyanurate, diallyl isocyanurate, and triallyl isocyanurate.

Examples of the allyl thioether include a monofunctional allyl thioether and a polyfunctional allyl thioether.

The monofunctional allyl thioether is a compound having one allyl group (—CH₂—CH═CH₂ group) and a thioether structure, and can be exemplified by alkylene glycol allyl thioethers.

The polyfunctional allyl thioether is a compound having two or more allyl groups (—CH₂—CH═CH₂ group) and a thioether structure, and can be exemplified by alkylene glycol diallyl thioethers.

Examples of the allylonium include monofunctional allyloniums and polyfunctional allyloniums, and specifically include monoallyltrialkylammonium salts, diallyldialkylammonium salts, and triallylmonoalkylammonium salts, and also include chlorides, bromides, and iodides thereof.

The compound having an allyl group (b) may be not only a monomer but also an oligomer or polymer of a compound such as allyl esters, allyl ethers, allylamines, allylcyanates, and allylthioethers.

Examples of the compound having an epoxy group include compounds having an epoxy group and an organic group such as an aliphatic hydrocarbon group, an aromatic hydrocarbon group or an alicyclic hydrocarbon group, and examples thereof include epichlorohydrin, ethylene oxide, propylene oxide, glycidyl phenyl ether, bisphenol A diglycidyl, bisphenol F diglycidyl, bisphenol S diglycidyl, and triglycidyl isocyanurate.

Examples of the compound having a hydroxyl group include compounds having a hydroxyl group and an organic group such as an aliphatic hydrocarbon group, an aromatic hydrocarbon group, or an alicyclic hydrocarbon group, and examples thereof include methanol, ethanol, phenol, and bisphenol A.

Examples of the compounds having a carboxyl group include acetic acid, oxalic acid, malonic acid, succinic acid, glutaric acid, adipic acid, pimelic acid, suberic acid, azelaic acid, sebacic acid, fumaric acid, maleic acid, citric acid, itaconic acid, phthalic acid, isophthalic acid, and terephthalic acid. The compound having a carboxyl group may be an acid anhydride, and examples thereof include phthalic anhydride, 4-methylhexahydrophthalic anhydride, and hexahydrophthalic anhydride.

Examples of the compound having a (meth)acryloyl group include compounds having a (meth)acryloyl group and an organic group such as an aliphatic hydrocarbon group, an aromatic hydrocarbon group, or an alicyclic hydrocarbon group, and examples thereof include methyl (meth)acrylate, ethyl (meth)acrylate, propyl (meth)acrylate, isopropyl (meth)acrylate, n-butyl (meth)acrylate, isobutyl (meth)acrylate, and n-pentyl (meth)acrylate.

Examples of the compound having an isocyanate group include compounds having an isocyanate group and an organic group such as an aliphatic hydrocarbon group, an aromatic hydrocarbon group, or an alicyclic hydrocarbon group, and examples thereof include aliphatic diisocyanates such as ethylene diisocyanate, tetramethylene diisocyanate, hexamethylene diisocyanate (HDI), dodecane diisocyanate, and tetradecane diisocyanate; alicyclic diisocyanates such as methylenedi(1,4-cyclohexylene isocyanate), isophorone diisocyanate (IPDI), cyclohexane-1,4-diisocyanate, 1,3-propylenebis(4-isocyanate cyclohexane), and norbornane diisocyanate (NBDI); and aromatic diisocyanates such as paraphenylene diisocyanate (PPDI), 4,4′-diphenylmethane diisocyanate (MDI), 2,4-toluene diisocyanate (TDI), 2,6-toluene diisocyanate (TDI), and m-xylylene diisocyanate (XDI).

Examples of the compound having a mercapto group include compounds having a mercapto group and an organic group such as an aliphatic hydrocarbon group, an aromatic hydrocarbon group, or an alicyclic hydrocarbon group, and examples thereof include methanethiol, ethanethiol, benzenethiol, trimethylolpropane tris(3-mercaptobutyrate), trimethylolethane tris(3-mercaptobutyrate), pentaerythritol tetrakis(3-mercaptobutyrate), 1,4-bis(3-mercaptobutyryloxy)butane, and 1,3,5-tris(3-mercaptobutyryloxyethyl)-1,3,5-triazine-2,4,6(1H,3H,5H)-trione.

Examples of the compound having a silanol group include compounds having a silanol group and an organic group such as an aliphatic hydrocarbon group, an aromatic hydrocarbon group, or an alicyclic hydrocarbon group, and examples thereof include dimethylsilanol and triethoxysilanol.

The content of the compound having a reactive functional group (b) in the nanosubstance-containing composition of the present invention is preferably 0.01 to 100 parts by mass, more preferably 0.05 to 95 parts by mass, and particularly preferably 0.1 to 90 parts by mass, for 100 parts by mass of the component (a) when the component (a) is a thermoplastic resin or a thermosetting resin. When the component (a) is a rubber, the content of the compound having a reactive functional group (b) is preferably 0.01 to 100 parts by mass, more preferably 0.05 to 50 parts by mass, and particularly preferably 0.1 to 20 parts by mass, for 100 parts by mass of the component (a).

### 3. Nanosubstance (c)

The nanosubstance (c) in the nanosubstance-containing composition of the present invention is preferably a filler selected from among a carbon nanofiller, an organic nanofiller, and an inorganic nanofiller, and it is more preferably a carbon nanofiller in terms of heat resistance. The nanosubstance is a substance having at least one dimension smaller than 200 nm; one having one dimension smaller than 200 nm and a spread in the remaining two dimensions is a substance with a thin film shape, one having two dimensions smaller than 200 nm and a spread in the remaining one dimension is a substance with a rod shape, and one having three dimensions all smaller than 200 nm is a substance with a granular shape. The shape is not particularly limited, but preferred is a substance with a rod shape having two dimensions smaller than 200 nm and a spread in the remaining one dimension.

Examples of the carbon nanofiller include carbon nanofibers, carbon nanohoms, carbon nanocones, carbon nanotubes, carbon nanocoils, carbon microcoils, fullerene, and graphene, among which carbon nanofibers and carbon nanotubes are preferred.

The organic nanofiller can be exemplified by (co)polymers having an alkyl methacrylate, an alkyl dimethacrylate, an alkyl acrylate, or an alkyl diacrylate, preferably methyl methacrylate, as a constitutional unit.

The inorganic nanofiller can be exemplified by glass fillers such as aluminum oxide, silicates, quartz, and barium glass filler, nanohydrated metal compounds, crystalline silica, fused silica, alumina, titania, aluminum nitride, boron nitride, and ceramic materials.

The upper limit of the content of the nanosubstance (c) in the nanosubstance-containing composition of the present invention is preferably 20 parts by mass or less, more preferably 10 parts by mass or less, for 100 parts by mass of the compound having a reactive functional group (b), and may be 5 parts by mass or less, 1 part by mass or less, 0.8 parts by mass or less, or 0.5 parts by mass or less. The lower limit is preferably 0.0001 parts by mass or more, more preferably 0.001 parts by mass or more, and particularly preferably 0.01 parts by mass or more.

### 4. Other Components

(1) The Case where the Component (a) is a Thermoplastic Resin

When the component (a) is a thermoplastic resin, the nanosubstance-containing composition of the present invention may contain various additives such as antioxidants of hindered amine type, hindered phenol type, sulfur-containing compound type, acrylate type, or phosphorus-containing organic compound type; UV absorbers such as benzophenone-based UV absorbers, benzotriazole-based UV absorbers, or triazine-based UV absorbers; mold release agents such as polyethylene wax, higher fatty acid esters, and fatty acid amides; lubricants; crystal nucleating agents; viscosity modifiers; colorants; surface-treating agents; pigments; fluorescent pigments; dyes; fluorescent dyes; coloring inhibitors; plasticizers; flame retardants such as red phosphorus, metal hydroxide flame retardants, phosphorus-based flame retardants, silicone-based flame retardants, halogen-based flame retardants, and combinations of halogen-based flame retardants with antimony trioxide; and antistatic agents according to the object or the necessity as long as the object or the effect of the present invention is not impaired.

When the component (a) is a thermoplastic resin, the nanosubstance-containing composition of the present invention can be produced by mixing (kneading) various materials, and the mixing (kneading) method is not particularly limited and may be a melt-kneading method using a mixing machine, such as an open roll, an intensive mixer, an internal mixer, a co-kneader, a continuous kneader with a twin-screw rotor, or an extruder. As the extruder, either a single-screw extruder or a twin-screw extruder can be used.

When the component (a) is a thermoplastic resin, the molded article of a nanosubstance-containing composition of the present invention contains the above-described nanosubstance-containing composition and is obtained by molding the nanosubstance-containing composition. For the molding of the nanosubstance-containing composition, injection molding, injection compression molding, extrusion forming, blow molding, tubular blow molding, vacuum molding, press molding, or the like can be used.

(2) The Case where the Component (a) is a Thermosetting Resin

When the component (a) is a thermosetting resin, the nanosubstance-containing composition of the present invention may contain a known curing agent according to the thermosetting resin contained; examples thereof in the case where an epoxy resin is contained include an amine-based curing agent, an amide-based curing agent, an acid anhydride-based curing agent, and a phenol-based curing agent, and examples in the case where a diallyl phthalate resin is contained include a peroxide-based curing agent. As to the curing agent, a single species thereof may be used, or alternatively two or more species thereof may be used in combination.

Examples of the curing agent include amine-based curing agents, amide-based curing agents, acid anhydride-based curing agents, phenol-based curing agents, imidazole-based curing agents, phosphine-based curing agents, peroxide-based curing agents, isocyanate-based curing agents, and aziridine-based curing agents.

Examples of the amine-based curing agent include diaminodiphenylmethane, diaminodiphenylethane, diaminodiphenyl ether, diaminodiphenylsulfone, orthophenylenediamine, metaphenylenediamine, paraphenylenediamine, metaxylenediamine, paraxylenediamine, diethyltoluenediamine, diethylenetriamine, triethylenetetramine, and isophoronediamine.

Examples of the amide-based curing agent include dicyandiamide and a polyamide resin synthesized from a dimer of linolenic acid and ethylenediamine.

Examples of the acid anhydride-based curing agent include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride.

Examples of the phenol-based curing agent include bisphenol A, bisphenol F, bisphenol S, resorcin, catechol, hydroquinone, fluorene bisphenol, 4,4′-biphenol, 4,4′,4″-trihydroxytriphenylmethane, naphthalenediol, 1,1,2,2-tetrakis(4-hydroxyphenyl)ethane, calixarene, a phenol novolac resin, a cresol novolac resin, an aromatic hydrocarbon formaldehyde resin-modified phenolic resin, a dicyclopentadiene phenol addition type resin, a phenol aralkyl resin (a xyloc resin), a polyhydric phenol novolac resin synthesized from a polyhydric hydroxy compound typified by a resorcin novolac resin and formaldehyde, a naphthol aralkyl resin, a trimethylolmethane resin, a tetraphenylolethane resin, a naphthol novolac resin, a naphthol-phenol co-condensed novolac resin, a naphthol-cresol co-condensed novolac resin, a biphenyl modified phenolic resin (a polyhydric phenol compound in which a phenol nucleus is linked with a bismethylene group), a biphenyl modified naphthol resin (a polyhydric phenol compound in which a phenol nucleus is linked with a bismethylene group), an aminotriazine-modified phenol resin (a polyhydric phenol compound in which a phenol nucleus is linked with melamine, benzoguanamine, or the like), and an alkoxy group-containing aromatic ring-modified novolac resin (a polyhydric phenol compound in which a phenol nucleus and an alkoxy group-containing aromatic ring are linked with formaldehyde).

Examples of the imidazole-based curing agent include 2-phenylimidazole, 2-phenyl-4-methylimidazole, 1-benzyl-2-methylimidazole, 1-benzyl-2-phenylimidazole, 1-cyanoethyl-2-undecylimidazole, 1-cyano-2-phenylimidazole, 1-cyanoethyl-2-undecylimidazole trimellitate, 1-cyanoethyl-2-phenylimidazolium trimellitate, 2,4-diamino-6-[2′-methylimidazolyl-(1′)-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, 2,4-diamino-6-[2′-methylimidazolyl-(1′)]-ethyl-s-triazine isocyanuric acid adduct, 2-phenylimidazole isocyanuric acid adduct, 2-phenyl-4,5-dihydroxymethylimidazole, 2-phenyl-4-methyl-5-hydroxymethylimidazole, and adducts of epoxy resin and imidazoles.

Examples of the phosphine-based curing agent includes triphenylphosphine, tetraphenylphosphonium tetraphenylborate, tetraphenylphosphonium tetra(4-methylphenyl)borate, and tetraphenylphosphonium (4-fluorophenyl)borate.

Examples of the peroxide-based curing agent include t-butylperoxy-2-ethylhexyl monocarbonate, 1,1-di(t-hexylperoxy)cyclohexane, 1,1-di(t-butylperoxy)-3,3,5-trimethylcvclohexane, t-butyl peroxyoctoate, benzoylperoxide, methyl ethyl ketone peroxide, acetylacetone peroxide, t-butyl peroxybenzoate, and dicumylperoxide.

Examples of the isocyanate-based curing agent include tolylene diisocyanate, diphenylmethane diisocyanate, hexamethylene diisocyanate, isophorone diisocyanate, xylylene diisocyanate, dicyclohexylmethane diisocyanate, 1,5-naphthalene diisocyanate, tetramethylxylylene diisocyanate, and trimethylhexamethylene diisocyanate.

Examples of the aziridine-based curing agent include trimethylolpropane-tri-β-aziridinyl propionate, tetramethylolmethane-tri-β-aziridinyl propionate, N,N′-diphenylmethane-4,4′-bis(1-aziridinecarboxamide), and N,N′-hexamethylene-1,6-bis(1-aziridinecarboxamide).

When the component (a) is a thermosetting resin, the content of the curing agent in the nanosubstance-containing composition of the present invention is preferably 0.1 to 20 parts by mass, more preferably 0.3 to 10 parts by mass, and particularly preferably 0.5 to 5 parts by mass, for 100 parts by mass of the thermosetting resin.

When the component (a) is a thermosetting resin, the nanosubstance-containing composition of the present invention may contain various additives such as antioxidants of hindered amine type, hindered phenol type, sulfur compound-containing type, acrylate type, or phosphorus-containing organic compound type; UV absorbers such as benzophenone-based UV absorbers, benzotriazole-based UV absorbers, or triazine-based UV absorbers; mold release agents such as polyethylene wax, higher fatty acid esters, and fatty acid amides; lubricants; crystal nucleating agents; viscosity modifiers; colorants; surface-treating agents; pigments; fluorescent pigments; dyes; fluorescent dyes; coloring inhibitors; curing agents; flame retardants such as red phosphorus, metal hydroxide flame retardants, phosphorus-based flame retardants, silicone-based flame retardants, halogen-based flame retardants, and combinations of halogen-based flame retardants with antimony trioxide; and antistatic agents according to the object or the necessity as long as the object or the effect of the present invention is not impaired.

When the component (a) is a thermosetting resin, the nanosubstance-containing composition of the present invention can be produced by mixing (kneading) various materials, and the mixing (kneading) method is not particularly limited and may be a melt-kneading method using a mixing machine, such as an open roll, an intensive mixer, an internal mixer, a co-kneader, a continuous kneader with a twin-screw rotor, or an extruder. As the extruder, either a single-screw extruder or a twin-screw extruder can be used.

When the component (a) is a thermosetting resin, the molded article contains the nanosubstance-containing composition of the present invention and is obtained by molding the nanosubstance-containing composition of the present invention. For the molding of the nanosubstance-containing composition of the present invention, injection molding, injection compression molding, extrusion forming, blow molding, tubular blow molding, vacuum molding, press molding, or the like can be used.

(3) The Case where Component (a) is Rubber

When the component (a) is a rubber, the nanosubstance-containing composition of the present invention may contain a crosslinking agent (a vulcanizing agent) according to the rubber contained.

The crosslinking agent (vulcanizing agent) for NBR is not particularly limited, and it generally may be any crosslinking agent that makes unsaturated bonds crosslink. Specifically, examples thereof include sulfur-based crosslinking agents, peroxide-based crosslinking agents, resin crosslinking agents, and oxime-based crosslinking agents, and sulfur-based crosslinking agents and peroxide-based crosslinking agents are preferred. The nanosubstance-containing composition may contain known accelerators, acceleration aids, or retarders appropriately according to the crosslinking agent, e.g., thiuram compounds such as tetramethyl disulfide, dithiocarbamates such as zinc diethyldithiocarbamate and copper dimethyldithiocarbamate (e.g., zinc salts of dithiocarbamic acid and copper salts of dithiocarbamic acid).

Examples of the sulfur-based crosslinking agent include sulfur and thiurams such as tetramethylthiuram disulfide, tetraethylthiuram disulfide, tetrabutylthiuram disulfide, tetramethylthiuram monosulfide, and dipentamethylenethiuram tetrasulfide.

Examples of the peroxide-based crosslinking agent include tert-butyl hydroperoxide, p-menthane hydroperoxide, dicumyl peroxide, tert-butyl peroxide, 1,3-bis(tert-butylperoxyisopropyl)benzene, 2,5-dimethyl-2,5-di(tert-butylperoxy)hexane, benzoyl peroxide, and tert-butyl peroxybenzoate.

Examples of the resin crosslinking agent include alkylphenol-formaldehyde resin, melamine-formaldehyde condensate, triazine-formaldehyde condensate, octylphenol-formaldehyde resin, alkylphenol-sulfide resin, and hexamethoxymethyl-melamine resin.

Examples of the oxime-based crosslinking agent include p-quinone dioxime, p-benzoquinone dioxime, and p,p′-dibenzoylquinone dioxime.

The compounding amount of the crosslinking agent (vulcanizing agent) is not limited as long as the effects of the present invention are not impaired, but it is preferably 0.1 to 10 parts by mass for 100 parts by mass of the NBR.

Regarding the type and the compounding amount of the crosslinking agent (vulcanizing agent) for the H—NBR and other compounding agents, known accelerators, acceleration aids, or retarders appropriately according to the crosslinking agent, e.g., thiuram compounds such as tetramethyl disulfide, dithiocarbamates such as zinc diethyldithiocarbamate and copper dibutyldithiocarbamate (e.g., zinc salts of dithiocarbamic acid and copper salts of dithiocarbamic acid) can be used in the same manner as in the NBR.

The crosslinking agent (vulcanizing agent) for the ACM is not particularly limited, and a known crosslinking agent may be appropriately used according to the monomer to be used for crosslinking sites. Examples of common crosslinking agents for chlorine group-based monomers to be used for crosslinking sites include hexamethylenediaminocarbamate, ethylenethiourea, N,N′-diethylthiourea, and dipentamethylenethiuram tetrasulfide (TRA). For active chlorine group-based monomers to be used for crosslinking sites, sulfur, TRA, diaminecarbamate, 2,4,6-trimercapto-1,3,5-triazine, and the like are used. For epoxy group-based monomers to be used for crosslinking sites, dithiocarbamates and ammonium organic carboxylates are used. Further, the peroxide-based crosslinking agents, etc. described in the section of the NBR can also be used. In addition, metal compounds, metal oxides, metal soaps, etc., acid acceptors such as dithiocarbamates, e.g., zinc diethyldithiocarbamate and copper dibutyldithiocarbamate (e.g., zinc salts of dithiocarbamic acid and copper salts of dithiocarbamic acid), accelerators, and various compounding agents are suitably used according to the individual crosslinking agents.

The compounding amount of the crosslinking agent (vulcanizing agent) is not limited as long as the effects of the present invention are not impaired, but it is preferably 0.1 to 10 parts by mass for 100 parts by mass of the ACM.

The crosslinking agent (vulcanizing agent) for the AEM is not particularly limited, and a known crosslinking agent is appropriately used. Examples of common crosslinking agents include diamine-based crosslinking agents such as hexamethylenediamine, hexamethylene diaminocarbamate, and ethylenediamine, and the peroxide-based crosslinking agents described in the section of the NBR. The rubber composition may contain known accelerators, acceleration aids, retarders, or various compounding agents appropriately according to the crosslinking agent, e.g., thiuram compounds such as tetramethyl disulfide, dithiocarbamates such as zinc diethyldithiocarbamate and copper dibutyldithiocarbamate (e.g., zinc salts of dithiocarbamic acid and copper salts of dithiocarbamic acid).

The compounding amount of the crosslinking agent (vulcanizing agent) is not limited as long as the effects of the present invention are not impaired, but it is preferably 0.1 to 10 parts by mass for 100 parts by mass of the AEM.

The crosslinking agent (vulcanizing agent) for the FKM is not particularly limited, and a known crosslinking system is appropriately used. Examples of the polyamine-based crosslinking agent include hexamethylenediamine carbamate, N,N′-dicinnamylidene-1,6-hexamethylenediamine, and 4,4′-bis(aminocyclohexyl)methane carbamate, examples of the polyol crosslinking agent include bisphenol S and bisphenol AF, and examples of the peroxide-based crosslinking agent include the various peroxides described in the section of the NBR. The nanosubstance-containing composition may contain known accelerators, acceleration aids, retarders, or various compounding agents appropriately according to the crosslinking agent, e.g., thiuram compounds such as tetramethyl disulfide, dithiocarbamates such as zinc diethyldithiocarbamate and copper dibutyldithiocarbamate (e.g., zinc salts of dithiocarbamic acid and copper salts of dithiocarbamic acid).

The compounding amount of the crosslinking agent (vulcanizing agent) is not limited as long as the effects of the present invention are not impaired, but it is preferably 0.1 to 10 parts by mass for 100 parts by mass of the FKM.

The crosslinking agent (vulcanizing agent) for the CR is not particularly limited, and a known crosslinking agent is appropriately used. Preferred examples of the known crosslinking agent include metal oxides, and specifically include zinc oxide, magnesium oxide, lead oxide, trilead tetraoxide, iron trioxide, titanium dioxide, and calcium oxide. Two or more species of these may be used in combination. Together with the crosslinking agent, thiourea-based accelerators, guanidine-based accelerators, thiuram-based accelerators, and thiazole-based accelerators may be used as an accelerator, and thiourea-based accelerators are preferred. Examples of the thiourea-based accelerators include ethylenethiourea, diethylthiourea, trimethylthiourea, trimethylthiourea, and N,N′-diphenylthiourea. Various compounding agents such as dithiocarbamates such as zinc diethyldithiocarbamate and copper dibutyldithiocarbamate (e.g., zinc salts of dithiocarbamic acid and copper salts of dithiocarbamic acid) may be contained.

The compounding amount of the crosslinking agent (vulcanizing agent) is not limited as long as the effects of the present invention are not impaired, and it is preferably 0.1 to 10 parts by mass for 100 parts by mass of the CR.

The crosslinking agent (vulcanizing agent) for the CSM is not particularly limited, and a known crosslinking agent is appropriately used. Examples of the known crosslinking agent include metal oxides such as magnesium oxide, maleimide compounds such as N,N′-m-phenylenedimaleimide, the peroxides described in the section of the NBR, and thiuram compounds such as dipentamethylenethiuram tetrasulfide, tetramethylthiuram disulfide, and tetraethylthiuram disulfide. It is allowable to use known accelerators, acceleration aids, retarders, and optionally anti-aging agents (e.g., amine-based anti-aging agents and phenol-based anti-aging agents) appropriately according to the crosslinking agent, e.g., dithiocarbamates such as zinc diethyldithiocarbamate and copper dibutyldithiocarbamate (e.g., zinc salts of dithiocarbamic acid and copper salts of dithiocarbamic acid).

The compounding amount of the crosslinking agent (vulcanizing agent) is not limited as long as the effects of the present invention are not impaired, but it is preferably 0.1 to 10 parts by mass for 100 parts by mass of the CSM.

The crosslinking agent (vulcanizing agent) for the CPE is not particularly limited, and a known crosslinking agent is appropriately used. Examples of the known crosslinking system include mercaptotriazine-based crosslinking agents such as trimercapto-S-triazine, 2-hexylamino-4,6-dimercaptotriazine, 2-diethylamino-4,6-dimercaptotriazine, 2-cyclohexylamino-4,6-dimercaptotriazine, 2-dibutylamino-4,6-dimercaptotriazine, 2-anilino-4,6-dimercaptotriazine, and 2-phenylamino-4,6-dimercaptotriazine, thiadiazole-based crosslinking agents such as 2,5-dimercapto-1,3,4-thiadiazole, a monobenzoate derivative of 2,5-dimercapto-1,3,4-thiadiazole, and a dibenzoate derivative of 2,5-dimercapto-1,3,4-thiadiazole; and the various peroxides described in the section of the NBR. The nanosubstance-containing composition may contain known accelerators, acceleration aids, retarders, or various compounding agents appropriately according to the crosslinking agent, e.g., thiuram compounds such as tetramethyl disulfide, dithiocarbamates such as zinc diethyldithiocarbamate and copper dibutyldithiocarbamate (e.g., zinc salts of dithiocarbamic acid and copper salts of dithiocarbamic acid).

The compounding amount of the crosslinking agent (vulcanizing agent) is not limited as long as the effects of the present invention are not impaired, and it is preferably 0.1 to 10 parts by mass for 100 parts by mass of the CPE.

The crosslinking agent (vulcanizing agent) for the EPM and the EPDM is not particularly limited, and a known crosslinking agent is appropriately used. Examples of the known crosslinking agent include sulfur-based crosslinking agents, peroxide-based crosslinking agents, resin crosslinking agents, and oxime-based crosslinking agents, and specifically include the sulfur-based crosslinking agents, peroxide-based crosslinking agents, resin crosslinking agents, and oxime-based crosslinking agents described in the section of the NBR. The nanosubstance-containing composition may contain known accelerators, acceleration aids, retarders, or various compounding agents appropriately according to the crosslinking agent, e.g., thiuram compounds such as tetramethyl disulfide, dithiocarbamates such as zinc diethyldithiocarbamate and copper dibutyldithiocarbamate (e.g., zinc salts of dithiocarbamic acid and copper salts of dithiocarbamic acid).

The compounding amount of the crosslinking agent (vulcanizing agent) is not limited as long as the effects of the present invention are not impaired, but it is preferably 0.1 to 10 parts by mass for 100 parts by mass of the EPM and/or the EPDM.

The crosslinking agent (vulcanizing agent) for the polyether rubber is not particularly limited, and it may be a known crosslinking agent (vulcanizing agent) that utilizes the reactivity of a halogen atom such as a chlorine atom, examples of which include polyamine crosslinking agents (vulcanizing agents), thiourea crosslinking agents (vulcanizing agents), thiadiazole crosslinking agents (vulcanizing agents), mercaptotriazine crosslinking agents (vulcanizing agents), pyrazine crosslinking agents (vulcanizing agents), quinoxaline crosslinking agents (vulcanizing agents), and bisphenol crosslinking agents (vulcanizing agents). When having polymerization units based on an ethylenically unsaturated group-containing oxirane such as allyl glycidyl ether and glycidyl methacrylate, the crosslinking agent (vulcanizing agent) may be a known crosslinking agent (vulcanizing agent) that is commonly used for vulcanization of nitrile rubbers, examples of which include sulfur-based crosslinking agents (vulcanizing agents), peroxide-based crosslinking agents (vulcanizing agents), resin-based crosslinking agents (vulcanizing agents), and quinone dioxime-based crosslinking agents (vulcanizing agents).

Examples of the polyamine-based crosslinking agents (vulcanizing agents) include ethylenediamine, hexamethylenediamine, diethylenetriamine, triethylenetetramine, hexamethylenetetramine, p-phenylenediamine, cumenediamine, N,N′-dicinnamylidene-1,6-hexadiamine, ethylenediamine carbamate, and hexamethylenediamine carbamate.

Examples of the thiourea-based crosslinking agents (vulcanizing agents) include ethylenethiourea, 1,3-diethylthiourea, 1,3-dibutylthiourea, and trimethylthiourea.

Examples of the thiadiazole-based crosslinking agents (vulcanizing agents) include 2,5-dimercapto-1,3,4-thiadiazole and 2-mercapto-1,3,4-thiadiazole-5-thiobenzoate.

Examples of the mercaptotriazine-based crosslinking agents (vulcanizing agents) include 2,4,6-trimercapto-1,3,5-triazine, 2-methoxy-4,6-dimercaptotriazine, 2-hexylamino-4,6-dimercaptotriazine, 2-diethylamino-4,6-dimercaptotriazine, 2-cyclohexaneamino-4,6-dimercaptotriazine, 2-dibutylamino-4,6-dimercaptotriazine, 2-anilino-4,6-dimercaptotriazine, and 2-phenylamino-4,6-dimercaptotriazine.

Examples of the pyrazine-based crosslinking agents (vulcanizing agents) include 2,3-dimercaptopyrazine derivatives, and examples of the 2,3-dimercaptopyrazine derivatives include pyrazine-2,3-dithiocarbonate, 5-methyl-2,3-dimercaptopyrazine, 5-ethylpyrazine-2,3-dithiocarbonate, 5,6-dimethyl-2,3-dimercaptopyrazine, and 5,6-dimethylpyrazine-2,3-dithiocarbonate.

Examples of the quinoxaline-based crosslinking agents (vulcanizing agents) include 2,3-dimercaptoquinoxaline derivatives, and examples of the 2,3-dimercaptoquinoxaline derivatives include quinoxaline-2,3-dithiocarbonate, 6-methylquinoxaline-2,3-dithiocarbonate, 6-ethyl-2,3-dimercaptoquinoxaline, 6-isopropylquinoxaline-2,3-dithiocarbonate, and 5,8-dimethylquinoxaline-2,3-dithiocarbonate.

Examples of the bisphenol-based crosslinking agents (vulcanizing agents) include 4,4′-dihydroxydiphenyl sulfoxide, 4,4′-dihydroxydiphenyl sulfone (bisphenol S), 1,1-cyclohexylidene-bis(4-hydroxybenzene), 2-chloro-1,4-cyclohexylene-bis(4-hydroxybenzene), 2,2-isopropylidene-bis(4-hydroxybenzene) (bisphenol A), hexafluoroisopropylidene-bis(4-hydroxybenzene) (bisphenol AF), and 2-fluoro-1,4-phenylene-bis(4-hydroxybenzene).

Examples of the sulfur-based crosslinking agents (vulcanizing agents) include sulfur, morpholine disulfide, tetramethylthiuram disulfide, tetraethylthiuram disulfide, tetrabutylthiuram disulfide, N,N′-dimethyl-N,N′-diphenylthiuram disulfide, dipentanemethylenethiuram tetrasulfide, dipentamethylenethiuram tetrasulfide, and dipentamethylenethiuram hexasulfide.

Examples of the peroxide-based crosslinking agents (vulcanizing agents) include tert-butyl hydroperoxide, p-menthane hydroperoxide, dicumyl peroxide, tert-butyl peroxide, 1,3-bis(tert-butylperoxyisopropyl)benzene, 2,5-dimethyl-2,5-di(tert-butylperoxy)hexane, benzoyl peroxide, and tert-butyl peroxybenzoate.

Examples of the resin-based crosslinking agents (vulcanizing agents) include alkylphenol-formaldehyde resins.

Examples of the quinone dioxime-based crosslinking agents (vulcanizing agents) include p-quinone dioxime and p-p′-dibenzoylquinone dioxime.

When a polyether rubber is used as the rubber, known accelerators and retarders can be used as they are together with the crosslinking agent (vulcanizing agent) in the present invention. Examples of the accelerator to be used in combination with a known crosslinking agent (vulcanizing agent) that utilize the reactivity of chlorine atoms include primary, secondary, and tertiary amines, organic acid salts of these amines or adducts thereof, guanidine-based accelerators, thiuram-based accelerators, and dithiocarbamic acid-based accelerators. Examples of the retarders include N-cyclohexanethiophthalimide and zinc salts of dithiocarbamic acid.

As the primary, secondary, and tertiary amines, especially, primary, secondary, and tertiary amines of aliphatic or cyclic fatty acids having 5 to 20 carbon atoms are preferred, and representative examples of such amines include n-hexylamine, octylamine, dibutylamine, tributylamine, and hexamethylenediamine.

Examples of the organic acid which forms a salt with an amine include carboxylic acids, carbamic acid, 2-mercaptobenzothiazole, and dithiophosphoric acid. Examples of the substance which forms an adduct with an amine include alcohols and oximes. Examples of the organic acid salt or adduct of an amine include n-butylamine acetate, hexamethylenediamine carbamate, and a dicyclohexylamine salt of 2-mercaptobenzothiazole.

Examples of the guanidine-based accelerator include diphenylguanidine and ditolylguanidine.

Examples of the thiuram-based accelerator include tetramethylthiuram disulfide, tetramethylthiuram monosulfide, tetraethylthiuram disulfide, tetrabutylthiuram disulfide, and dipentamethylenethiuram tetrasulfide.

Examples of the dithiocarbamic acid-based accelerator include a piperidine salt of pentamethylenedithiocarbamic acid.

The compounding amount of the accelerator or retarder to be used in combination with a known crosslinking agent (vulcanizing agent) that utilizes the reactivity of chlorine atoms is preferably 0 to 10 parts by mass, more preferably 0.1 to 5 parts by mass for 100 parts by mass of the polyether rubber.

Examples of accelerators, retarders, acceleration aids, and crosslinking aids to be used in combination with a sulfur-based crosslinking agent (vulcanizing agent), a peroxide-based crosslinking agent (vulcanizing agent), a resin-based crosslinking agent (vulcanizing agent), or a quinone dioxime-based crosslinking agent (vulcanizing agent) include various types of accelerators such as aldehyde ammonia-based accelerators, aldehyde amine-based accelerators, thiourea-based accelerators, guanidine-based accelerators, thiazole-based accelerators, sulfenamide-based accelerators, thiuram-based accelerators, dithiocarabamic acid salt-based accelerators, and xanthogenic acid salt-based accelerators; retarders such as N-nitrosodiphenylamine, phthalic anhydride, and N-chclohexylthiophathalimide; acceleration aids such as zinc flower, stearic acid, and zinc stearate; and various crosslinking aids such as quinone dioxime-based crosslinking aids, methacrylate-based crosslinking aids, allyl-based crosslinking aids, and maleimide-based crosslinking aids.

The compounding amount of the accelerator, the retarder, the acceleration aid, and the crosslinking aid to be used in combination with the sulfur-based crosslinking agent (vulcanizing agent), peroxide-based crosslinking agent (vulcanizing agent), resin-based crosslinking agent (vulcanizing agent), or quinone dioxime-based crosslinking agent (vulcanizing agent) is preferably 0 to 10 parts by mass, more preferably 0.1 to 5 parts by mass for 100 parts by mass of the rubber component.

When a polyether rubber is used as the rubber, the crosslinking agent (vulcanizing agent) is preferably contained in an amount of 0.1 to 10 parts by mass for 100 parts by mass of the polyether rubber. More preferably, it is contained in an amount of 0.5 to 5 parts by mass.

For crosslinking, ultraviolet rays, visible light, electron beams, and the like can be used, and a photoreaction initiator may be used. Examples of the photoreaction initiator include alkylphenone initiators, benzophenone initiators, acylphosphine oxide initiators, titanocene initiators, triazine initiators, bisimidazole initiators, and oxime ester initiators. Preferably, photoreaction initiators such as alkylphenone-based initiators, benzophenone-based initiators, and acylphosphine oxide-based initiators are used. It is also possible to use two or more of the above-mentioned compounds in combination as a photoreaction initiator.

Examples of the alkylphenone-based initiator include 2,2-dimethoxy-1,2-diphenylethan-1-one, 1-hydroxycyclohexyl-phenyl-ketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-[4-[4-(2-hydroxy-2-methyl-propionyl)-benzyl]phenyl]-2-methyl-propan-1-one, and 2-methyl-1-(4-methylthiophenyl)-2-morpholinopropan-1-one. Preferred are 2,2-dimethoxy-1,2-diphenylethan-1-one, 1-hydroxycyclohexyl-phenyl-ketone, 2-hydroxy-2-methyl-1-phenyl-propan-1-one, and 2-methyl-1-(4-methylthiophenyl)-2-morpholinopropan-1-one.

Examples of the benzophenone-based initiator include benzophenone, 2-chlorobenzophenone, 4,4′-bis(diethylamino)benzophenone, 4,4′-bis(dimethylamino)benzophenone, and methyl 2-benzoylbenzoate. Benzophenone, 4,4′-bis(diethylamino)benzophenone, and 4,4′-bis(dimethylamino)benzophenone are preferred.

Examples of the acylphosphine oxide-based initiator include 2,4,6-trimethylbenzoyl-diphenyl-phosphine oxide and bis(2,4,6-trimethylbenzoyl)-phenylphosphine oxide. Bis(2,4,6-trimethylbenzoyl)-phenylphosphine oxide is preferred.

The upper limit of the amount of the photoreaction initiator to be used for the crosslinking reaction is preferably 0.01 parts by mass or more, more preferably 0.1 parts by mass or more for 100 parts by mass of the polyether rubber, and the lower limit is preferably 6 parts by mass or less, more preferably 4 parts by mass or less.

When the component (a) is a rubber, the nanosubstance-containing composition of the present invention may contain various additives such as antioxidants of hindered amine type, hindered phenol type, sulfur compound-containing type, acrylate type, or phosphorus-containing organic compound type; UV absorbers such as benzophenone UV absorbers, benzotriazole UV absorbers, or triazine UV absorbers; mold release agents such as polyethylene wax, higher fatty acid esters, and fatty acid amides; lubricants; crystal nucleating agents; viscosity modifiers; colorants; surface-treating agents; pigments; fluorescent pigments; dyes; fluorescent dyes; coloring inhibitors; curing agents; flame retardants such as red phosphorus, metal hydroxide flame retardants, phosphorus-based flame retardants, silicone-based flame retardants, halogen-based flame retardants, and combinations of halogen-based flame retardants with antimony trioxide; and antistatic agents according to the object or the necessity as long as the object or the effect of the present invention is not impaired.

When the component (a) is a rubber, the nanosubstance-containing composition of the present invention can be produced by mixing (kneading) various materials, and the mixing (kneading) method is not particularly limited and may be a melt-kneading method using a mixing machine, such as an open roll, an intensive mixer, an internal mixer, a co-kneader, a continuous kneader with a twin-screw rotor, or an extruder. As the extruder, either a single-screw extruder or a twin-screw extruder can be used.

When component (a) is a rubber, a molded article of the nanosubstance-containing composition of the present invention is obtained by molding. For the molding of the nanosubstance-containing composition of the present invention, injection molding, injection compression molding, extrusion forming, blow molding, tubular blow molding, vacuum molding, press molding, or the like can be used.

When the component (a) is a rubber, a molded article of the nanosubstance-containing composition of the present invention may be one crosslinked and molded (crosslink-molded) with a crosslinking agent (vulcanizing agent) being contained in the nanosubstance-containing composition. The molded article obtained by crosslink-molding is obtained usually via a step of heating to 100 to 200° C. The crosslinking time varies depending on the temperature, but it is usually between 0.5 and 300 minutes. As a method of crosslink-molding, any method can be used, for example, compression molding with a mold (also referred to as press crosslinking), injection molding, steam can, air bath, heating with infrared rays or microwaves. When the component (a) is a rubber, a molded article of the nanosubstance-containing composition of the present invention can be made to undergo a crosslinking reaction by applying active energy rays such as ultraviolet rays during or after the molding with the nanosubstance-containing composition containing a photoreaction initiator and a crosslinking aid. In the case of using ultraviolet rays, a xenon lamp, a mercury lamp, a high pressure mercury lamp, and a metal halide lamp can be used, and the crosslinking reaction can be carried out by applying the rays at an integrated exposure of 1 to 10000 mJ/cm² using a UV irradiator with a high pressure mercury lamp as a light source.

### Properties of the Nanosubstance-Containing Composition of the Present Invention

The nanosubstance-containing composition of the present invention is characterized by containing a component (a) that is at least one species selected from the group consisting of a thermoplastic resin, a thermosetting resin, and a rubber, a compound having a reactive functional group (b), and a nanosubstance (c); it is superior in heat resistance when it contains a thermoplastic resin or rubber of the present invention, and it provides a nanosubstance-containing composition with high toughness when it contains a thermosetting resin.

Furthermore, since the nanosubstance-containing composition of the present invention concurrently contains the component (a), the compound having a reactive functional group (b), and the nanosubstance (c), a molded article obtained from the nanosubstance-containing composition is suitably reduced in volume resistance value.

The volume resistance value of a molded article of the nanosubstance-containing composition of the present invention is not particularly limited, but it is preferably 10¹⁵ Ω·cm or less, more preferably 10¹⁴ Ω·cm or less when component (a) is a thermoplastic resin, for example; it is preferably 10¹⁵ Ω·cm or less, more preferably 10¹⁴ Ω·cm or less when the component (a) is a thermosetting resin, for example; and it is preferably 10¹⁵ Ω·cm or less, more preferably 10¹⁴ Ω·cm or less when the component (a) is a rubber, for example. The lower limit of the volume resistance value is about 10⁸ Ω·cm, for example.

### Examples of a Particularly Preferable Composition of the Nanosubstance-Containing Composition of the Present Invention

As described above, the nanosubstance-containing composition of the present invention is characterized by containing a component (a) that is at least one species selected from the group consisting of a thermoplastic resin, a thermosetting resin, and a rubber, a compound having a reactive functional group (b), and a nanosubstance (c); it is superior in heat resistance when it contains a thermoplastic resin or rubber, and high toughness is exhibited and a superior property that a volume resistance value is suitably reduced is exhibited when it contains a thermosetting resin. Among nanosubstance-containing compositions that exhibit such superior properties, examples of a particularly preferable composition are shown below.

One example is a nanosubstance-containing composition in which the component (a) includes a thermoplastic resin selected from the group consisting of polypropylene resins and polycarbonate resins, a thermosetting resin selected from the group consisting of epoxy resins and diallyl isophthalate prepolymers, or a rubber selected from among polyether rubbers, a compound having an allyl group such as diallyl phthalate, the above-described acid anhydride, or the above-described compound having a mercapto group is contained as the compound having a reactive functional group (b), and carbon nanotubes, carbon nanofibers, carbon nanohoms, carbon nanocones, or graphene is contained as the nanosubstance (c).

Especially, the proportion of the compound having a reactive functional group (b) is particularly preferably about 0.5 to 10 parts by mass for 100 parts by mass of the component (a) when the compound (b) is a compound having an allyl group such as diallyl phthalate or the above-described compound having a mercapto group, and it is particularly preferably about 80 to 100 parts by mass when the compound (b) is the above-described acid anhydride.

In addition, it is particularly preferable that the amount of the nanosubstance (c) be about 0.005 to 0.1 parts by mass for 100 parts by mass of the component (a).

More specifically, particularly preferable compositions are exemplified by the compositions described below.

When the component (a) is a thermoplastic resin, a particularly preferred composition may be, for example, a nanosubstance-containing composition that contains at least one of a polypropylene resin and a polycarbonate resin as the component (a), diallyl isophthalate as the compound having a reactive functional group (b), and carbon nanotubes as the nanosubstance (c). In the nanosubstance-containing composition, it is particularly preferable that the proportion of the compound having a reactive functional group (b) be about 0.5 to 8 parts by mass and the proportion of the nanosubstance (c) be about 0.005 to 0.1 parts by mass for 100 parts by mass of the component (a).

When the component (a) is a thermosetting resin, a particularly preferable composition may be, for example, a nanosubstance-containing composition that contains a diallyl isophthalate prepolymer (the above-described peroxide-based curing agent is preferably used as a curing agent) as the component (a), diallyl isophthalate as the compound having a reactive functional group (b), and carbon nanotubes as the nanosubstance (c). In the nanosubstance-containing composition, it is particularly preferable that the proportions of the compound having a reactive functional group (b) be about 0.5 to 15 parts by mass and the proportions of the nanosubstance (c) be about 0.005 to 0.1 parts by mass for 100 parts by mass of the component (a) (the amount of the peroxide-based curing agent is about 0.5 to 5 parts by mass).

When the component (a) is a thermosetting resin, another particularly preferred composition may be, for example, a nanosubstance-containing composition that contains an epoxy resin as the component (a), the above-described acid anhydride as the compound having a reactive functional group (b), and carbon nanotubes as the nanosubstance (c). In the nanosubstance-containing composition, it is particularly preferable that the proportion of the compound having a reactive functional group (b) be about 80 to 100 parts by mass and the proportion of the nanosubstance (c) be about 0.001 to 0.1 parts by mass for 100 parts by mass of the component (a).

When the component (a) is a rubber, a particularly preferred composition may be, for example, a nanosubstance-containing composition that contains a polyether copolymer (a crosslinking agent is preferably used) as the component (a), diallyl isophthalate as the compound having a reactive functional group (b), and carbon nanotubes as the nanosubstance (c). In the nanosubstance-containing composition, it is particularly preferable that the proportions of the compound having a reactive functional group (b) be about 0.5 to 10 parts by mass and the proportions of the nanosubstance (c) be about 0.005 to 0.1 parts by mass for 100 parts by mass of the component (a) (the amount of the crosslinking agent is about 0.5 to 3 parts by mass).

When the component (a) is a rubber, another particularly preferred composition may be, for example, a nanosubstance-containing composition that contains an EO/EB/AGE terpolymer as the component (a), the above-described compound having a mercapto group as the compound having a reactive functional group (b), and carbon nanotubes as the nanosubstance (c). In the nanosubstance-containing composition, it is particularly preferable that the proportion of the compound having a reactive functional group (b) be about 0.5 to 10 parts by mass and the proportion of the nanosubstance (c) be about 0.005 to 0.1 parts by mass for 100 parts by mass of the component (a).

Hereafter, the present invention will be described in more detail by way of examples, but the present invention is not limited to the following examples as long as the gist thereof is not exceeded. In the following examples and comparative examples, each amount of loading means parts by mass.

1. The Case where Component (a) is Thermoplastic Resin

The raw materials of each of the nanosubstance-containing compositions of the example and the comparative examples are described below.

### Component (a)

### Thermoplastic Resin

a-1: Polypropylene resin “NOBLEN H501” produced by Sumitomo Chemical Co., Ltd.
a-2: Polycarbonate resin “Panlite 1225Y” produced by Teijin Ltd.

### Compound Having Reactive Functional Group (b)

b: Diallyl isophthalate “DAISO DAP 100 Monomer” produced by Osaka Soda Co., Ltd.

### Nanosubstance (c)

c-1: “TUBALL” with a diameter of 1.8 nm produced by OCSIAL
c-2: “MWNT” with a diameter of 40 nm produced by MEIJO NANO CARBON Co., Ltd.
c-3: “VGCF-1” with a diameter of 150 nm produced by Showa Denko K.K.

### <Preparation of Nanosubstance-Containing Composition and Preparation of Specimen>

### Examples 1 to 3 and Comparative Example 1

A pellet (resin molded article) of a nanosubstance-containing composition was produced by preparing the components shown in Table 1 in the proportions shown in the same table, feeding them to an extruder at a screw rotation speed of 150 rpm using a twin-screw extruder (“HK-25D” manufactured by Parker Corporation, L/D=41), and melt-kneading them. Cylinder temperature was changed depending on the resin to be used. (a-1: 180° C. a-2: 250° C.)

### <Evaluation Method>

### (Heat Resistance)

About 10 mg of the above-prepared pellet was subjected to measurement of a heat loss onset temperature T1 (° C.) at a heating rate of 10° C./min in a nitrogen atmosphere in accordance with JIS K7120 using a TG/DTA analyzer [model “EXSTAR 6000”, manufactured by SII Nano Technology Inc.], and similar measurement of a heat loss onset temperature T0 (° C.) of the pellet before being fed to the twin-screw kneading extruder, and the temperature difference (ΔT=T1−T0) is shown in Table 1. The higher the temperature difference (ΔT), the better the heat resistance. Measurement was not carried out in Comparative Examples 2 and 3.

TABLE 1

| | | | | | | Comparative | | |
|---|---|---|---|---|---|---|---|---|
| | | Example | | | | Example | | |
| | | 1 | 2 | 3 | 4 | 1 | 2 | 3 |
| Thermoplastic resin (a) | a-1 | 95 | 95 | 95 | | 95 | 95 | |
| | a-2 | | | | 95 | | | 95 |
| Compound having a reactive | b | 5 | 5 | 5 | 5 | 5 | | |
| functional group (b) | | | | | | | | |
| Nanosubstance (c) | c-1 | 0.01 | | | | | 0.01 | 0.01 |
| | c-2 | | 0.0075 | | | | | |
| | c-3 | | | 0.25 | 0.25 | | | |
| ΔT | [° C.] | 1.5 | 1.2 | 1.0 | 2.3 | −0.9 | — | — |

Unit: part(s) by mass (thermoplastic resin (a), compound having a reactive functional group (b), nanosubstance (c))

As shown in Table 1, it was found that when the component (a) was a thermoplastic resin, a molded article produced from a nanosubstance-containing composition of the present invention was superior in heat resistance.

2. The Case where Component (a) is Thermosetting Resin

A nanosubstance-containing composition was obtained by kneading materials in the proportions shown in Table 2 at 80° C. using a 9 inch roll. The obtained nanosubstance-containing composition was pressed (70 t) using a disc-shaped mold with a diameter of 10 mm, and thus a molded article was obtained. A specimen was obtained by cutting the obtained molded article.

TABLE 2

| | Comparative | |
|---|---|---|
| | Example 4 | Example 5 |
| Dially isophthalate | 100 | 90 |
| prepolymer *1 | | |
| Diallyl isophthalate *2 | | 10 |
| Nanosubstance *3 | | 0.01 |
| Dicumyl peroxide | 2 | 2 |

Unit: parts by mass
*1 Diallyl isophthalate prepolymer “DAISO ISODAP” produced by Osaka Soda Co., Ltd.
*2 Diallyl isophthalate “DAP 100 Monomer” produced by Osaka Soda Co., Ltd.
*3 Nanosubstance (carbon nanotube) “e-DIP S EC 2.0” with a particle diameter of 2.4 nm produced by MEIJO NANO CARBON Co., Ltd.

<Flexural Strength Measurement>

The obtained molded articles of Comparative Example 4 and Example 5 were subjected to measurement of flexural strength in accordance with JIS K7171 using “STROGRAPH W” manufactured by Toyo Seiki Seisaku-sho, Ltd. The results are shown in Table 3.

TABLE 3

| | Comparative | |
|---|---|---|
| | Example 4 | Example 5 |
| Flexural strength (MPa) | 74.1 | 84.9 |

It has been shown that as compared with Comparative Example 4, flexural strength is improved in Example 5.

3. The Case where Component (a) is Rubber

### <Analysis of Polymer>

As to the copolymerization composition of the polyether polymers obtained in the following Examples and Comparative Examples, a polyether polymer was dissolved in deuterochloroform, followed by calculating the integral values of individual units by ¹H-NMR, and then a composition ratio was determined from the calculated results. As a device, JNM GSX-270 manufactured by JEOL Ltd. was used.

The weight average molecular weight of the polyether polymers obtained in Examples and Comparative Examples was determined by gel permeation chromatography (GPC) by the following method.

Device: GPC system manufactured by Shimadzu Corporation
Column: Shodex KD-807, KD-806M, KD-806, KD-803 manufactured by Showa Denko K.K.
Detector: Differential refractometer
Solvent: Dimethylformamide (lithium bromide 1 mmol/L)
Flow rate: 1 mL/min
Column temperature: 60° C.
Molecular weight standard substance: Standard polystyrene produced by Showa Denko K.K.

### <Production of Polymerization Catalyst>

A three-necked flask equipped with a production stirrer for a polymerization catalyst, a thermometer, and a condenser was charged with 10 g of tributyltin chloride and 35 g of tributyl phosphate, which were heated at 250° C. for 20 minutes with stirring under a nitrogen stream to distill off a distillate, and thus a condensate which is solid at room temperature was obtained as a residue. Hereafter, this was used as a polymerization catalyst (hereinafter referred to as a condensate catalyst).

### <Example of Polymer Synthesis>

The inside of a jacketed stainless steel reactor with an inner capacity of 10 L was purged with nitrogen, and 10 g of the above-described condensate catalyst, 480 g of 1,2-butylene oxide, 126 g of glycidyl methacrylate (also referred to as GMA), and 3750 g of n-hexane as a solvent are charged, and 644 g of ethylene oxide (also referred to as EO) was sequentially added while monitoring the polymerization ratio of 1,2-butylene oxide by gas chromatography. After a lapse of 8 hours while maintaining the reaction temperature at 28° C., 16 g of methanol was added to terminate the polymerization reaction. After collecting a granular polymer by decantation, it was dried under reduced pressure at 40° C. for 8 hours, and thus 806 g of a polyether copolymer was obtained. The copolymerization composition of the resulting polyether copolymer was 68 mol % of a constitutional unit derived from ethylene oxide, 28 mol % of a constitutional unit derived from 1,2-butylene oxide, and 4 mol % of a constitutional unit derived from glycidyl methacrylate. The weight average molecular weight of the resulting polyether copolymer was 1,900,000.

Materials with the composition shown in Table 4 were kneaded with a kneader, and thus a composition was obtained. Each of the compositions of Example 6 and Comparative Example 5 was spread on a mold and pressed for 2 minutes with a vacuum heating pressing machine controlled at a temperature of 160° C. to form a 0.5 mm thick polymer sheet, which were then irradiated with light at 500 mJ/cm² by using a UV irradiation machine with a high pressure mercury lamp as a light source, and thus a crosslinked sheet (molded article) was obtained.

### <Evaluation Method>

### (1) Heat Resistance:

About 10 mg of the above-prepared sheet was subjected to measurement of a 50% heating loss temperature (° C.) at a heating rate of 10° C./min in a nitrogen atmosphere in accordance with JIS K7120 using a TG/DTA analyzer [model “EXSTAR 6000”, manufactured by SII Nano Technology Inc.], and the measured result is shown in Table 4. The higher the temperature, the better in heat resistance the sheet.

TABLE 4

| | | Comparative |
|---|---|---|
| | Example 6 | Example 5 |
| Polyether copolymer *1 | 100 | 100 |
| Diallyl isophthalate *2 | 5 | 5 |
| Nanosubstance *3 | 0.01 | |
| 2-Methyl-1-(4-methylthiophenyl)-2- | 1.5 | 1.5 |
| morpholinopropan-1-one *4 | | |
| 50% Heating loss temperature (° C.) | 388 | 378 |

Unit: parts by mass (compounded material)
*1 Polyether copolymer prepared in polymer synthesis example
*2 “DAP 100 Monomer” produced by Osaka Soda Co., Ltd.
*3 “e-DIPS EC2.0” with a particle diameter of 2.4 nm produced by MEIJO NANO CARBON Co., Ltd.
*4 “IRGACURE 907” produced by BASF

As shown in Table 4, the molded article of Example 6 is higher in 50% heating loss temperature (° C.) and superior in heat resistance as compared with the molded article of Comparative Example 5.

### 4. Evaluation of Volume Resistance Value

(1) The Case where the Component (a) is a Thermoplastic Resin

The raw materials of the compositions of Examples and Comparative Examples are described below.

### Component (a)

Thermoplastic resin Polycarbonate resin “Panlite 1225Y” produced by Teijin Ltd.

### Compound Having Reactive Functional Group (b)

Diallyl isophthalate “DAISO DAP 100 Monomer” produced by Osaka Soda Co., Ltd.

### Nanosubstance (c)

Carbon Nanotube “eDIPS2.0” produced by MEUO NANO CARBON Co., Ltd.

### Others

Carbon black “KETJENBLACK EC” produced by Lion Corporation

### <Preparation of Nanosubstance-Containing Composition and Preparation of Specimen>

### Examples 7, 8 and Comparative Examples 6 to 8

The raw materials were fed with the compounding shown in Table 1 into the hopper of a vented twin-screw extruder to obtain a nanosubstance-containing composition. Using an injection molding machine (Model “FNX80III-9A”, manufactured by Nissei Plastic Industrial Co., Ltd.), the above-described nanosubstance-containing composition was molded to form a specimen under the condition specified by a cylinder temperature of 250° C. and a mold temperature of 70° C. It is noted that the unit of a compounding composition is part(s) by mass.

### <Measurement of Volume Resistance Value>

For the 1 mm thick, 40 mm square molded articles injected with the compounding of Examples 7, 8 and Comparative Examples 6 to 8, following conditioning for 48 hours in a dry booth adjusted to a dew point of −50° C., specimens were allowed to stand, and thus the molded articles were dried.

### <Measurement>

Each of the dried specimens of Examples 7, 8 and Comparative Examples 6 to 8 was conditioned for 48 hours in a steady temperature and humidity chamber adjusted to a temperature of 23° C. and a humidity of 50% RH (hereinafter sometimes referred to as 23° C.×50% RH” or “23° C. 50%”), and the volume resistance value thereof was measured in the steady temperature and humidity chamber. In the measurement, a voltage of 100 to 1000 V was applied using an insulation resistance meter (Hiresta-UX MCP-HT800, manufactured by Mitsubishi Chemical Corporation), and the resistance value after 1 minute was read to calculate a volume resistance value. The measurement results are shown in Table 5.

TABLE 5

| | | | | Comparative | Comparative | Comparative |
|---|---|---|---|---|---|---|
| | | Example 7 | Example 8 | Example 6 | Example 7 | Example 8 |
| Component (a) | Polycarbonate | 100 | 100 | 100 | 100 | 100 |
| Thermoplastic resin | (PC1225Y) | | | | | |
| Compound having a | iDAP | 1 | 1 | 1 | 1 | — |
| reactive functional | | | | | | |
| group (b) | | | | | | |
| Nanosubstance (c) | Carbon nanotube | 0.01 | 0.03 | — | — | 0.03 |
| | (eDIPS2.0) | | | | | |
| Others | Carbon black | — | — | 0.03 | — | — |

| | | | | | |
|---|---|---|---|---|---|
| Volume resistance value [Ω · cm] | 7.5 × 10¹⁴ | 6.2 × 10¹³ | >10¹⁷ | >10¹⁷ | >10¹⁷ |

(2) The Case where the Component (a) is a Thermosetting Resin

The raw materials of the compositions of Examples and Comparative Examples are described below.

### Component (a)

Thermosetting resin Epoxy resin “JER 828” produced by Japan Epoxy Resin Co., Ltd.

### Compound Having Reactive Functional Group (b)

4-Methylhexahydrophthalic anhydride/hexahydrophthalic anhydride=70/30 “RIKACID MH-700” produced by New Japan Chemical Co., Ltd.

### Nanosubstance (c)

Carbon Nanotube “eDIPS2.0” with a particle diameter of 2.4 nm produced by MEIJO NANO CARBON Co., Ltd.

### Others

Carbon black “KETJENBLACK EC” with a particle diameter of 400 nm produced by Lion Corporation

### <Preparation of Nanosubstance-Containing Composition and Preparation of Specimen>

### Examples 9, 10 and Comparative Examples 9 to 11

In accordance with the compounding shown in Table 6, 0.25 parts of the raw materials and tris(dimethylamino)phenol were added to and mixed with 100 parts of an epoxy resin, and thus a nanosubstance-containing composition was obtained. The nanosubstance-containing composition was poured into a mold and allowed to stand in an oven at a temperature of 150° C. for 15 hours to form a specimen. It is noted that the unit of a compounding composition is part(s) by mass.

### <Measurement of Volume Resistance Value>

For the 2 mm thick, 50 mm square molded articles injected with the compounding of Examples 9, 10 and Comparative Examples 9 to 11, following conditioning for 48 hours in a dry booth adjusted to a dew point of −50° C., specimens were allowed to stand, and thus the molded articles were dried.

### <Measurement>

Each of the dried specimens of Examples 9, 10 and Comparative Examples 9 to 11 was conditioned for 48 hours in a steady temperature and humidity chamber adjusted to a temperature of 23° C. and a humidity of 50% RH (hereinafter sometimes referred to as “23° C.×50% RH” or “23° C. 50%”), and the volume resistance value thereof was measured in the steady temperature and humidity chamber. In the measurement, a voltage of 100 to 1000 V was applied using an insulation resistance meter (Hiresta-UX MCP-HT800, manufactured by Mitsubishi Chemical Corporation), and the resistance value after 1 minute was read to calculate a volume resistance value. The measurement results are shown in Table 6.

TABLE 6

| | | | Example | Comparative | Comparative | Comparative |
|---|---|---|---|---|---|---|
| | | Example 9 | 10 | Example 9 | Example 10 | Example 11 |
| Component (a) | Epoxy resin | 100 | 100 | 100 | 100 | 100 |
| Thermosetting resin | (JER828) | | | | | |
| Compound having a | Acid anhydride | 86.2 | 86.2 | 86.2 | 86.2 | — |
| reactive functional | (RIKACID MH-700) | | | | | |
| group (b) | | | | | | |
| Nanosubstance (c) | Carbon nanotube | 0.0019 | 0.019 | — | — | 0.019 |
| | (eDIPS2.0) | | | | | |
| Others | Carbon black | — | — | 0.019 | — | — |

| | | | | | |
|---|---|---|---|---|---|
| Volume resistance value [Ω · cm] | 6.0 × 10⁸ | 1.0 × 10⁶ | >10¹⁷ | >10¹⁷ | >10¹⁷ |

(3) The Case where Component (a) is Rubber

The raw materials of the compositions of Examples and Comparative Examples are described below.

### Component (a)

Polyether copolymer prepared in Synthesis Example of polyether polymer 2 described later

### Compound Having Reactive Functional Group (b)

Pentaerythritol tetrakis(3-mercaptobutyrate) “Karenz MT PE-1” produced by SHOWA DENKO K.K.

### Nanosubstance (c)

Carbon Nanotube “eDIPS2.0” with a particle diameter of 2.4 nm produced by MEIJO NANO CARBON Co., Ltd.

### Others

Carbon black “KETJENBLACK EC” with a particle diameter of 400 nm produced by Lion Corporation

### <Preparation of Nanosubstance-Containing Composition and Preparation of Specimen>

### Examples 11, 12 and Comparative Examples 12 to 14

The compounding shown in Table 7 was dissolved in methyl isobutyl ketone to achieve a solid concentration of 10% by mass, followed by addition of 1.0 parts by mass of a photopolymerization initiator Irgacure 907 (2-methyl-1-(4-methylthiophenyl)-2-morpholinopropan-1-one) for 100 parts by mass of the polyether copolymer, and thus a homogeneous solution was obtained. After dripping a certain amount of the solution on a PET film, it was applied with an applicator, followed by evaporating methyl isobutyl ketone, and a uniform 100 μm thick film was thereby prepared. The front and back surfaces were irradiated with 100 mJ/cm² using a UV irradiator with a high pressure mercury lamp as a light source to obtain a crosslinked film (molded article).

### <Measurement of Volume Resistance Value>

For the 80 μm thick, 50 mm square molded articles injected with the compounding of Examples 11, 12 and Comparative Examples 12 to 14, following conditioning for 48 hours in a dry booth adjusted to a dew point of −50° C., specimens were allowed to stand, and thus the molded articles were dried.

### <Measurement>

Each of the dried specimens of Examples 11, 12 and Comparative Examples 12 to 14 was conditioned for 48 hours in a steady temperature and humidity chamber adjusted to a temperature of 23° C. and a humidity of 50% RH (hereinafter sometimes referred to as “23° C.×50% RH” or “23° C. 506%”), and the volume resistance value thereof was measured in the steady temperature and humidity chamber. In the measurement, a voltage of 100 to 1000 V was applied using an insulation resistance meter (Hiresta-UX MCP-HT800, manufactured by Mitsubishi Chemical Corporation), and the resistance value after 1 minute was read to calculate a volume resistance value. The measurement results are shown in Table 7.

### (Synthesis Example of Polyether Copolymer 2 Described Above)

The inside of a jacketed stainless steel reactor with an inner capacity of 10 L was purged with nitrogen, 10 g of the above-described condensate catalyst, 1017 g of 1,2-epoxybutane (also referred to as EB), 56 g of allyl glycidyl ether, and 3752 g of n-hexane as a solvent were charged, and 80 g of ethylene oxide (also referred to as EO) was sequentially added while monitoring the polymerization ratio of 1,2-epoxybutane by gas chromatography. After a lapse of 8 hours while maintaining the reaction temperature at 28° C., 16 g of methanol was added to terminate the polymerization reaction. After collecting a granular polymer by decantation, it was dried under reduced pressure at 40° C. for 8 hours, and thus 457 g of a polyether copolymer was obtained. The copolymerization composition of the resulting polyether copolymer was 14 mol % of a constitutional unit derived from ethylene oxide, 82 mol % of a constitutional unit derived from 1,2-epoxybutane, and 4 mol % of a constitutional unit derived from allyl glycidyl ether. The weight average molecular weight of the resulting polyether copolymer was 1,800,000.

TABLE 7

| | | Example | Example | Comparative | Comparative | Comparative |
|---|---|---|---|---|---|---|
| | | 11 | 12 | Example 12 | Example 13 | Example 14 |
| Component (a) | Terpolymer | 100 | 100 | 100 | 100 | 100 |
| Rubber | (EO/EB/AGE (T28- | | | | | |
| | 6)) | | | | | |
| Compound having a | Thiol | 4 | 4 | 4 | 4 | — |
| reactive functional | (Karenz MT PE-1) | | | | | |
| group (b) | | | | | | |
| Nanosubstance (c) | Carbon nanotube | 0.01 | 0.1 | — | — | 0.1 |
| | (eDIPS2.0) | | | | | |
| Others | Carbon black | — | — | 0.1 | — | — |

| | | | | | |
|---|---|---|---|---|---|
| Volume resistance value [Ω · cm] | 3.8 × 10⁷ | 1.9 × 10⁸ | 6.6 × 10¹⁰ | 6.6 × 10¹⁰ | 6.6 × 10¹⁰ |

1. A nanosubstance-containing composition comprising:
(a) at least one component selected from the group consisting of a thermoplastic resin, a thermosetting resin, and a rubber;
(b) compound having a reactive functional group; and
(c) a nanosubstance.

2. The nanosubstance-containing composition according to claim 1, wherein the compound having a reactive functional group is a compound having at least one or more reactive functional groups selected from the group consisting of a vinyl group, an allyl group, an epoxy group, a hydroxyl group, a carboxyl group, a (meth)acryloyl group, an isocyanate group, a mercapto group, and a silanol group.

3. The nanosubstance-containing composition according to claim 1, wherein the compound having a reactive functional group is a compound having a boiling point of 100° C. or higher at normal pressure.

4. The nanosubstance-containing composition according to claim 1, wherein the nanosubstance is at least one nanofiller selected from the group consisting of carbon-based nanofillers, organic nanofillers, and inorganic nanofillers.

5. The nanosubstance-containing composition according to claim 1, wherein the thermosetting resin is an allyl resin.

6. A cured product of the nanosubstance-containing composition according to claim 1.

7. A molded article produced from the nanosubstance-containing composition according to claim 1.

8. The nanosubstance-containing composition according to claim 2, wherein the compound having a reactive functional group is a compound having a boiling point of 100° C. or higher at normal pressure.

9. The nanosubstance-containing composition according to claim 2, wherein the nanosubstance is at least one nanofiller selected from the group consisting of carbon-based nanofillers, organic nanofillers, and inorganic nanofillers.

10. The nanosubstance-containing composition according to claim 3, wherein the nanosubstance is at least one nanofiller selected from the group consisting of carbon-based nanofillers, organic nanofillers, and inorganic nanofillers.

11. The nanosubstance-containing composition according to claim 2, wherein the thermosetting resin is an allyl resin.

12. The nanosubstance-containing composition according to claim 3, wherein the thermosetting resin is an allyl resin.

13. The nanosubstance-containing composition according to claim 4, wherein the thermosetting resin is an allyl resin.

14. A cured product of the nanosubstance-containing composition according to claim 2.

15. A cured product of the nanosubstance-containing composition according to claim 3.

16. A cured product of the nanosubstance-containing composition according to claim 4.

17. A cured product of the nanosubstance-containing composition according to claim 5.

18. A molded article produced from the nanosubstance-containing composition according to claim 2.

19. A molded article produced from the nanosubstance-containing composition according to claim 3.

20. A molded article produced from the nanosubstance-containing composition according to claim 4.
